(19) United States
(12) Patent Application Publication
(10) Pub. No.: US 2002/0062287 A1
(43) Pub. Date: May 23, 2002

(54) Peripheral device detection and notification

(76) Inventors: James S. Katz, Bedford, MA (US); Christine S. Nevin, Shrewsbury, MA (US); Raymond Shapiro, Marlboro, MA (US)

Correspondence Address: LUCASH, GESMER & UPDEGROVE, LLP, 40 BROAD ST, SUITE 300, BOSTON, MA, 02109, US

(21) Appl. No.: 09/918,323

(22) Filed: Jul. 30, 2001

Related U.S. Application Data
(60) Provisional application No. 60/235,496, filed on Sep. 26, 2000.

(51) Int. Cl. G06F 17/60; H04K 1/00; H04L 9/00

(52) U.S. Cl. 705/51

(57) ABSTRACT

Disclosed are systems, devices and methods for deployment in digital set-top boxes and associated networks to enable t-commerce and other transactions responsive to events generated by peripheral devices.

### CROSS REFERENCE TO RELATED APPLICATION

This application for United States patent claims the priority of related, commonly owned U.S. provisional application for Pat. Ser. No. 60/235,496, filed Sep. 26, 2000, the disclosure of which is incorporated in its entirety herein by reference.

### FIELD OF THE INVENTION

The present invention relates to interactive television set-top boxes (STBs) generally, and, in particular, relates to methods and systems for initiating e-commerce and t-commerce (television commerce) transactions in response to detection of installation or removal of peripheral devices or other events generated by a peripheral device. Thus, for example, the invention provides systems for responding to a “Low Ink” event or message from a printer by automatically navigating to an e-commerce URL to enable the user to order additional ink.

### BACKGROUND OF THE INVENTION

Microsoft TV (MSTV) contains a client/server subsystem for maintaining software or data modules on the client, referred to as the Client Configuration Architecture. This architecture permits the client to subscribe to a software module, such as a device driver or application, so that the target software is installed and maintained on the client via an interaction with the server.

Current STBs typically have the ability to support multiple peripheral devices through, inter alia, serial, parallel, USB, 1394 and other interfaces. Recently developed hardware designs will permit an end-user to plug in a growing number of peripheral devices (“peripherals”) including, but not limited to, digital cameras (both still and video), scanners and printers.

Additional information regarding STBs is found in G. O'Driscoll, The Essential Guide to Digital Set-top Boxes and Interactive TV, 2000, Prentice-Hall, Inc., which is incorporated herein by reference.

While Windows CE and Microsoft TV are expected to support a basic device driver module for each of these interfaces, as well as some devices that are plugged in after system initialization, they lack an automated peripheral identification mechanism that can respond to events generated by peripheral devices during operation (rather than simply at device activation or insertion), and can not support devices if the necessary software is not resident on the client at the time of device activation or insertion.

A number of patents disclose systems for device detection. Among these are the following, the disclosures of which are incorporated herein by reference:

U.S. Pat. No. 6,023,585, which discloses automatically selecting and downloading device drivers from a server system to a client system that includes one or more devices;

U.S. Pat. No. 6,003,097, which discloses a system for automatically configuring a network adapter without manual intervention by using a registry data structure maintained within a computer system memory;

U.S. Pat. No. 5,787,246, which discloses a system for configuring devices for a computer system; and

U.S. Pat. No. 5,655,148,which discloses a method for automatically configuring devices including a network adapter without manual intervention and without prior configuration information.

Of these, U.S. Pat. No. 6,023,585 discloses a system in which at system initialization, the host processing system requests the peripheral devices to which it is coupled to each provide a device code for identifying the type of the peripheral device. The host processing system receives the device codes from the peripheral devices and transmits the device codes to a remote server over a network, such as the Internet. The remote server selects an appropriate device driver for each peripheral device from a plurality of stored device drivers based on the device codes received from the host processing system and then transmits the device drivers to the host processing system over the network. This driver download process is carried out with no intervention from the user.

However, these systems are limited to only detecting the devices at system initialization. They cannot dynamically detect device activation (for example, inserting and MP3 player once the system has started)

Moreover, these systems do not enable initiation of e-commerce, t-commerce and other transactions on the basis of device events that may be generated during operation, and not merely based upon driver installation; and none facilitates support of drivers that are installed on a temporary basis.

Since the STB is a consumer device targeted at a non-technical audience, ease of use is of paramount importance in deploying software and software upgrades and in conducting e-commerce and other transactions.

Accordingly, it is desirable to provide systems that facilitate “on-demand”, or run-time deployment of software and software upgrades, as well as initiation of e-commerce and other transactions, in the STB environment. It is also desirable to provide systems that enable and facilitate the initiation of data transfer, e-commerce and other digital transactions, responsive to device generated events, which may be generated, for example, at device installation or removal, or at other times during device operation.

### SUMMARY OF THE INVENTION

The invention comprises systems, devices and methods responsive to peripheral device detection and notification, which are useful in connection with set-top boxes (STBs) and other client devices. In one aspect, the invention comprises a Peripheral Interface Agent (PIA) that enables the dynamic detection and recognition of peripheral devices installed in or removed from a television set top box (STB) while the STB system is operating, and the initiation of e-commerce transactions in response to such detection. For example, the PIA can interface between the low-level device architecture provided in Windows CE and the Microsoft TV CCA (Client Configuration Agent—the client side of the Client Configuration Architecture). The invention thus includes device discovery, device event handling, and server-side aspects.

Device Discovery:

The device discovery aspects include systems, devices and method of invoking retrieval of software or data from a first source to a peripheral device capable of communicating with the first source, by (1) detecting a device event generated by the peripheral device, (2) transmitting to the first source, in response to detection of a device event, a request to obtain the software or data from the first source, and (3) receiving the software or data from the first source. The software or data are selected to be appropriate for the peripheral device in response to the event generated by the peripheral device, and the detecting, transmitting, and receiving are performed automatically when a device event is detected, without intervention by the user of the peripheral device.

In one example, the peripheral device is in communication with a client system, and the detecting, transmitting and receiving can be executed even when the client system contains no device driver to support the peripheral device. Software thereby obtained can be installed on the client system without a user of the client system manually installing the software. The software or data from the first source can include a device driver appropriate for the peripheral device; the request to obtain software or data can include a code identifying a device type of the peripheral device; and the first source can be a local source on the client system. The device event may be generated upon user interaction with the peripheral device, such as by actuation of a device START button. In another example, the first source of software or data is specified by an identifier designating an entry in a database on a remote processor capable of communicating with the client system via a communications channel, and the request is transmitted to the remote processor via the communications channel. The communications channel can include the Internet or World Wide Web.

In another practice of the invention, the transmitting of a request for the software or data can include opening, in response to detection of a device event, a communications channel with the first source, to enable access to libraries, packaging or configuration data on the first source to establish a repository of device drivers and supporting applications suitable for the peripheral device. Similarly, the step of receiving software or data from the first source can include receiving a package containing data, script files or software to augment a local database to enable handling of previously unsupported devices. The packages may include device driver packages defined in accordance with a standard format, and may define the manner of responding to peripheral devices; and the package itself may reside on the client system, or on the first source of data or software, and obtained from the first source after detection of the device event. In a particular implementation of the invention, the method includes responding to events originating on a home network operating in accordance with a home network standard such as the American National Standards Institute (ANSI) home network standard.

Event Handler:

The device event handler aspects include systems, devices and methods for responding to device events generated by a peripheral device, by (1) detecting a device event generated by the peripheral device when the peripheral device is in communication with a client system (2) transmitting from the client system to a first source of software or data, in response to detection of the device event, a request to obtain software or data from the first source, and (3) receiving the software or data from the first source. The software or data is selected to be appropriate for the peripheral device in response to the event generated by the peripheral device. The detecting, transmitting, and receiving are performed automatically when a device event is detected, without intervention by a user of the peripheral device, and can be executed even when the client system contains no device driver to support the peripheral device. The receiving can include receiving from the first source (which may include a database, broadcast carousel, or the like) a package containing any of data, script files or software to enable a response to the detected device event. In addition, the method can include enabling a sequence of responses to the detected device event, the sequence being defined by the data or software in the package. The sequence of responses, in turn, can include initiating a software program or otherwise activating specified software. The event can be generated at peripheral device detection time, during device operation, power-up, power-down or connection or disconnection with or from a client processing system, or at client system power-up. It can also be generated upon user interaction with the peripheral device (such as by actuating a peripheral device START button).

The invention also includes systems, devices and methods for responding to events generated by a peripheral device in communication with a client system, by (1) detecting an event generated by the peripheral device, and (2) responding to the event generated by the peripheral device, by executing a corresponding function, without intervention by the user of the client system. The function can be defined on the basis of either the event or the peripheral device, and may comprise navigation to a web site (including navigating to a predetermined web page when no other response to a given event is defined) and initiation of an e-commerce transaction.

In another example, the method includes detecting changes in one or more peripheral devices during operation of the peripheral devices, by detecting events generated by the peripheral devices, and dynamically responding to the detected changes to manage new devices or events. In this manner, the client system supports peripheral devices attached thereto, either before or after powering-up the client system, even when no supporting device driver currently exists on the client system at the time the device is attached to the client system.

In particular implementations of the invention, the method includes detecting events generated on a bus in communication with the client system (wherein the bus may operate in accordance with a predefined bus protocol, such as USB or IEEE-1394) or originating on a wireless network in communication with the client system; and responding to events originating on a home network operating in accordance with a home network standard (such as the American National Standards Institute (ANSI) standard).

The systems and methods can also include, upon detection of an event associated with a device or device class represented in a list of event classes, initiating a response to the event, wherein the response is among a list of possible responses to events specified in the list of event classes, for each of a set of devices or devices classes. This aspect may include associating, with a given device, an extensible list of possible sequences of responses to events in each event class. The system can store a list of devices and device events that can be extended without modification to base client system software; and can also store, in the first source of data or software, at least one extensible set of mappings of event types and corresponding responses, including an extensible list of event types and responses not previously encountered or supported by the client system. These characteristics enable the system to respond to detection of event types and devices not previously encountered or supported by the system.

In addition, the system may include detecting a new event type not previously encountered or supported by the client system, and opening a communications channel with the first source to obtain a package of software or data specifying a response to the new event type. The mode of responding to peripheral devices may be defined by a package resident on the client system, or on the first source. The package can be resident in the client system or obtained from the first source after detection of the device event. Still further, the method may include detecting a device type for the device, and responding to newly encountered, unsupported devices based on the detected device type.

The methods of the invention can also include navigating to a default Web page when no software can be obtained from the first source to support the device; permitting device-driver-originated events to initiate interaction with a user of the peripheral device, via a user interface; and permitting the user, following initiation of interaction, to control the peripheral device through the user interface. A standard format can be employed to define browser navigation directives, define or initiate device events, and/or communicate runtime or device event-specific data.

The invention also enables third parties to implement, in software, specific responses to device events, wherein the specific responses to device events can include device events not previously encountered by the system. Third party implementation can be supported by establishing a common interface definition for use by third parties, and permitting third parties to download extensible user interface software modules, to enable extensibility of code or functions associated with responses to device event. Specific response implementations can be defined to the client system using a standard format such as World Wide Web Consortium (W3C) XML.

Server Side:

The server side aspect of the invention includes systems and methods for providing a configurable intermediary between a client device and a digital processing system, by (1) receiving from the client device a peripheral device signal representative of an event generated by a peripheral device connected to the client device; (2) processing the peripheral device signal to generate an intermediary signal, the intermediary signal having a selectable, standardized format capable of being understood by the digital processing system; and (3) transmitting, to the digital processing system, the intermediary signal. The standardized format can be selected based on parameters of the digital processing system. The processing step can be executed on a server processor capable of communication with the client device via a communications channel such as the Internet; and the client device can be a television set-top box. The digital processing system can be a billing system, or information delivery, storage or logging system.

In response to receipt of the intermediary signal, the digital processing system can execute an e-commerce transaction process; or can provide an application program and e-commerce user interface that supports interactive e-commerce between a user of a client device and one or more vendors, by permitting the user to select items from a menu of product/service categories, and then registering the user's purchase of one or more items from the categories. This may include navigation to a Web site, and/or initiating an e-commerce transaction. The e-commerce user interface can be provided on a set-top box, PC, Internet appliance or other device capable of connecting to the Internet via a wireless or wire-line channel.

The systems and methods can also include (1) receiving peripheral device signals from each of a plurality of client devices; (2) selecting, for each of the received peripheral device signals, a respective, selectable, standardized format associated with the respective peripheral device signal and a selected one of a plurality of digital processing systems; (3) processing the respective peripheral device signal to generate an intermediary signal with a format capable of being processed by the selected digital processing system; and (4) routing and transmitting, to appropriate ones of the plurality of digital processing systems, respective intermediary signals. In each case, the peripheral device signal can be a peripheral device identifier. In addition to providing information regarding the peripheral, the system can also transmit an identifier for the STB, and either the peripheral identifier or the STB identifier can be associated with a credit card number for billing; or with a subscriber to a service provided by an entity and implemented by the digital processing system.

The invention also includes systems, devices and methods for using a configurable intermediary between a client system and a first source of software or data to respond to events generated by a peripheral device connected to the client system, by (1) receiving from the client system a peripheral device signal representative of an event generated by a peripheral device connected to the client device; (2) processing the peripheral device signal to generate an intermediary signal having a selectable, standardized format capable of being understood by the first source, and (3) responding to the event generated by the peripheral device, by executing a corresponding function, without intervention by the user of the client system, wherein the function is executed with reference to software or data obtained from the first source of software or data in response to receipt of the intermediary signal. The responding step includes opening, in response to the intermediary signal, a communications channel between the client system and the first source, to enable access to any of libraries, packaging or configuration data on the first source to establish a repository of device drivers and supporting applications suitable for the peripheral device.

In each case, the systems and methods can include logging device activity into a database (such as an Extensible Markup Language (XML) database), or a billing system. At least a portion of the billing system or information logged thereto can be stored in a client system capable of communication with the peripheral device; or on a remote server. The systems and methods can also permit device-driver-originated events to initiate interaction with a user of the peripheral device, via a user interface; permitting the user, following initiation of interaction, to control the peripheral device through the user interface; and utilizing a standard format to define device driver packages, communicate device event-specific data, or communicate runtime data.

The invention will also support drivers that are installed on a temporary basis. This is important because set top boxes are generally very resource constrained. Temporary driver support allows a driver to be installed through PIA and used for an indeterminate amount of time. When the driver is not in use, it will be removed from the system. However, the invention will track the fact that the device was configured on the system so the next time it is installed, it won't appear to the user that it is a first time installation.

### DEFINITION OF CERTAIN TERMS EMPLOYED HEREIN

Bus enumerator—A device driver that identifies devices located on a specific bus and assigns a unique identification code to each device.

Channel—A collection of resources described by a Channel Definition Format (CDF) file. The CDF file defines a hierarchy of elements included in the channel. In addition to defining the resources in the channel, the CDF file also specifies how each item will be deployed on the client, and when the channel should be updated. Thus, MSOs (see definition below) can deliver content directly to STBs (see definition below) on a regular schedule by transmitting the content to them through a channel. No STB user interaction is required to maintain a channel.

DLL—Dynamic Link Library, a library of executable functions or data that can be used by a Windows application. Typically, a DLL provides one or more particular functions and a program accesses the functions by creating either a static or dynamic link to the DLL.

MSO—Multiple Cable System Operator (wherein the term “cable” is used to refer to cable television (also called CATV or community antenna television).

MSTV—Collective reference to the Microsoft TV systems.

PIA—Peripheral Interface Agent, the device recognition and transaction initiating agent of the transactional system of the invention described herein.

STB—Set-top box.

CCA—Client Configuration Agent, client-resident components of the Client Configuration Architecture in Microsoft TV systems—responsible for requesting updated content such as device drivers, databases, etc.

CCS—Client Configuration Server, server-resident components of the Client Configuration Architecture in Microsoft TV systems—responsible for storage and delivery of the content CCA requests.

### BRIEF DESCRIPTION OF THE DRAWINGS

The present invention is illustrated by way of example and not limitation in the figures of the accompanying drawings, in which like references indicate similar elements and in which:

FIG. 1 illustrates an MSTV client system connected to a server system over the Internet.

FIG. 2 illustrates an MSTV client system.

FIG. 3 illustrates internal features of an MSTV STB in block diagram form.

FIG. 4 illustrates the internal features of an MSTV server in block diagram form.

FIG. 5 illustrates an MSTV STB connected to one or more peripheral devices.

FIG. 6A-6F are a flow diagrams illustrating methods in accordance with the invention.

FIG. 7 is a schematic diagram depicting PIA architecture in accordance with the invention.

FIG. 8 depicts method steps executed by the architecture of FIG. 7.

FIG. 9 depicts active logging architecture in accordance with the invention.

FIG. 10 depicts method steps executed in accordance with a further practice of the invention.

FIGS. 11-16 depict screenshots generated by the InterAct! aspects of the invention.

### DETAILED DESCRIPTION OF THE INVENTION

The following detailed description is organized into the following major sections:

Section I: Overview

Section II: Functional Description

Section III: Client Architecture

Section IV: Server Architecture

### Section I: Overview

In the discussion set forth hereinafter, for purposes of explanation, specific details are set forth in order to provide a thorough understanding of the invention. It will be appreciated by those skilled in the art that the present invention may be practiced without these specific details. In particular, those skilled in the art will appreciate that the methods described herein can be implemented in devices, systems and software other than Microsoft TV and CCS/CCA, and the examples set forth herein are provided by way of illustration rather than limitation. In other instances, conventional or otherwise well-known structures and devices are shown in block diagram form in order to facilitate description of the present invention.

The present invention includes steps that may be embodied in machine-executable software instructions, and thus the present invention includes a method that is carried out in a processing system as a result of a processor executing the instructions. In other embodiments, hardware elements may be employed in place of, or in combination with, software instructions to implement the present invention.

In one embodiment, the present invention is included in a system known as Microsoft TV, which utilizes a standard television set as a display device for browsing the World Wide Web (“the Web”) and which connects to the Internet using a standard telephone modem apparatus, cable modem, or other similar communication path. A user of a Microsoft TV client system can access, via the Internet, digital data, content and services provided by one or more remote servers, in accordance with known Internet practice. Thus the Microsoft TV services may be employed in combination with software running in the Microsoft TV client system, to enable the user to browse the Web, send electronic mail, and otherwise employ the Internet.

Although the present invention is described herein as implemented in the Microsoft TV system for illustrative purposes, the invention can also be implemented in other contexts, such as in other STB environments, conventional personal computers (PCs), workstations, or other processing environments.

The invention comprises a transactional system responsive to events associated with installation, removal or other device generated events occurring during operation of peripheral devices in the STB environment. Thus, for example, the invention can respond to a “Low Ink” event or message from a printer connected to the STB, by automatically navigating to an e-commerce URL to enable the user to order additional ink. The agent that enables this functionality is referred to herein as the PIA. Thus, a key purpose of the PIA is device discovery. When a device is plugged into an interface, the PIA will recognize that the device has appeared on the system and will become an agent for the user to install the appropriate software for the device. The PIA will contain a database of all devices known to have supporting drivers or other software on the PIA server. This database can be itself managed by Microsoft TV CCA, so that new devices, drivers and software can be added to the PIA database over time.

In accordance with a preferred practice of the invention, the PIA database will permit various kinds of device installation and operation scenarios, including automatic (hidden) installation, user notification through the Microsoft TV browser, and optional software installation. For each particular device, multiple scenarios can be permitted and supported. For example, when an imaging device such as a camera is plugged into a USB port, the PIA could install a device driver automatically and then prompt the user to install, and potentially purchase, optional software such as an application, to enhance the usability of the device.

By way of further example, when a user plugs a printer into the set top box, the PIA could prompt the user to enter into an e-commerce transaction, such as the purchase of additional paper, toner or other supplies, or font software or other applications. Thus, an additional significant component of the invention comprises methods and systems for initiating and conducting e-commerce transactions in response to device detection, removal or other device related events. As noted above, by way of example, the PIA can respond to a “Low Ink” event or message from a printer by automatically causing the browser to navigate to an e-commerce URL to enable the user to order additional ink.

These abilities to link devices to optional applications, and to invoke a purchase event or other e-commerce or digital transaction upon device insertion, removal or other device related events, constitute significant advantages over prior art systems and methods.

In a preferred embodiment of the invention, PIA could monitor device installations on the system so that devices that are removed or replaced would have their attendant software also removed. The removal of software typically adds a level of complication, in that user interaction would be required for removal of purchased software. PIA could eliminate this requirement of user interaction.

PIA can also contain and provide software enhancements to the Microsoft TV CCA, as required. For example, the PIA could permit the management of multiple devices and applications that may not be able to simultaneously reside on a client system.

In addition, PIA will support drivers that are installed on a temporary basis. This is important because set top boxes are generally very resource constrained. Temporary driver support allows a driver to be installed through PIA and used for an indeterminate amount of time. When the driver is not in use, it will be removed from the system. However, PIA will track the fact that the device was configured on the system so the next time it is installed, it won't appear to the user that it is a first time installation. This is important because PIA allows processing based upon device events and it might make sense for some peripherals to distinguish between a first time installation and subsequent enumerations (or installs) of the same device. Additionally, a driver (or other software component) may maintain data on the STB (e.g. registry settings) with its current operational settings. When support is installed on a temporary basis, these settings should remain for use the next time the software is installed. For example, the first time installation of a specific digital camera may result in a flash movie playing showing the operations of the camera. Subsequent enumerations may result in an automatic navigation to a photo album web site. If this is the desired result, this should occur whether or not the driver needs to be re-installed each time.

The invention described herein would be useful for MSOs, set top OEMs, ISVs and peripheral vendors. For MSOs, PIA can offer the ability to support new software and peripherals, as well as enhanced flexibility in their deployments. For ISVs, PIA can offer an automated mechanism to offer targeted software titles. For peripheral vendors, PIA permits driver and support software installation. Significantly, peripheral vendors will be able to enter into the set top box market regardless of whether the peripheral was available when the set top box was originally developed.

In one practice of the invention, the PIA architecture can be implemented in several modules, including one manager and one module for each hardware interface that PIA is to support. Significant interfaces in the system include those between PIA and, in one example, the Microsoft TV CCA modules; as well as between PIA and the browser, to generate potential e-commerce transactions, as in the example of navigating to a vendor URL to enable the purchase of additional printer supplies.

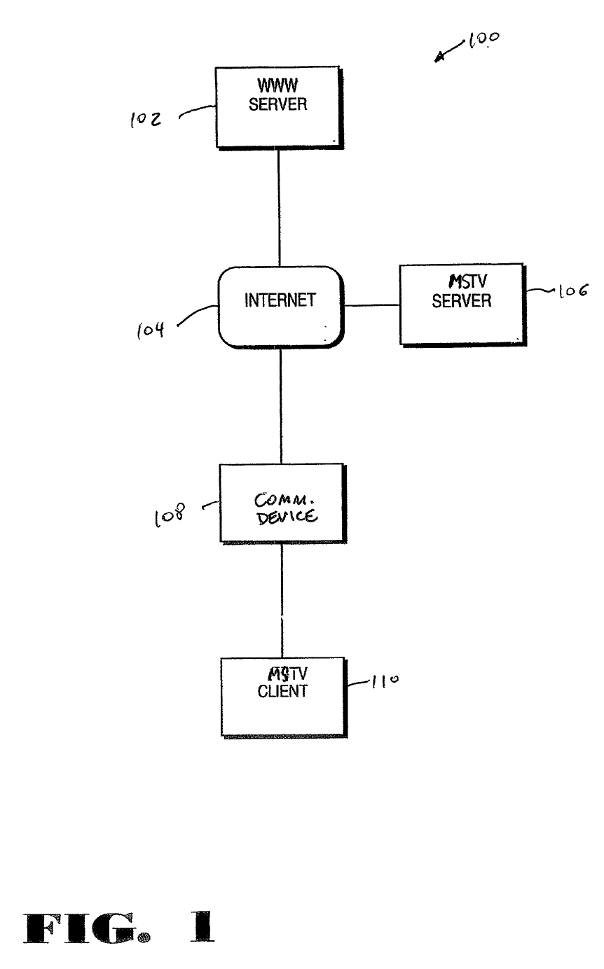

With reference to the attached FIGS. 1-5, FIG. 1 illustrates a well-known configuration of conventional MSTV network, typical of the prior art, for which the invention is adapted, and for which the invention can provide additional functionality. As shown in FIG. 1, a client device 110 is in communication with at least one remote Internet server 106, such as an MSTV server, via the Internet 104 or other network infrastructure and a communications device 108, such as a conventional cable modem or the like. The remote server generally includes one or more conventional computer systems. The server may comprise multiple physical and logical devices connected in a distributed architecture. The system can also include a World Wide Web Server 102.

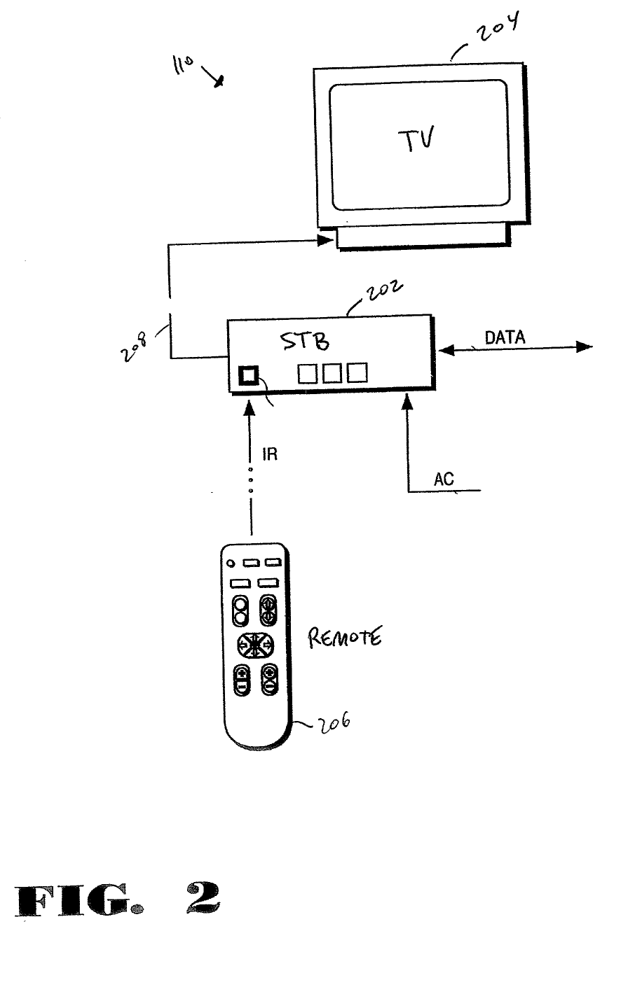

FIG. 2 illustrates a conventional MSTV client system 110 including an electronic STB 202, a conventional television set 204, and a conventional, hand-held remote control unit 206. The STB 202 includes hardware and software for providing the user with a graphical user interface (GUI) by which the user can browse the Internet, send e-mail, and access other Internet services. The user can employ remote control 206 to control the client system to browse the Web and perform other functions. The STB 202 receives commands from the remote control 206 and is coupled to the television set by a link 208. Each of these aspects is discussed in detail in the above-cited U.S. patents, which are incorporated by reference herein.

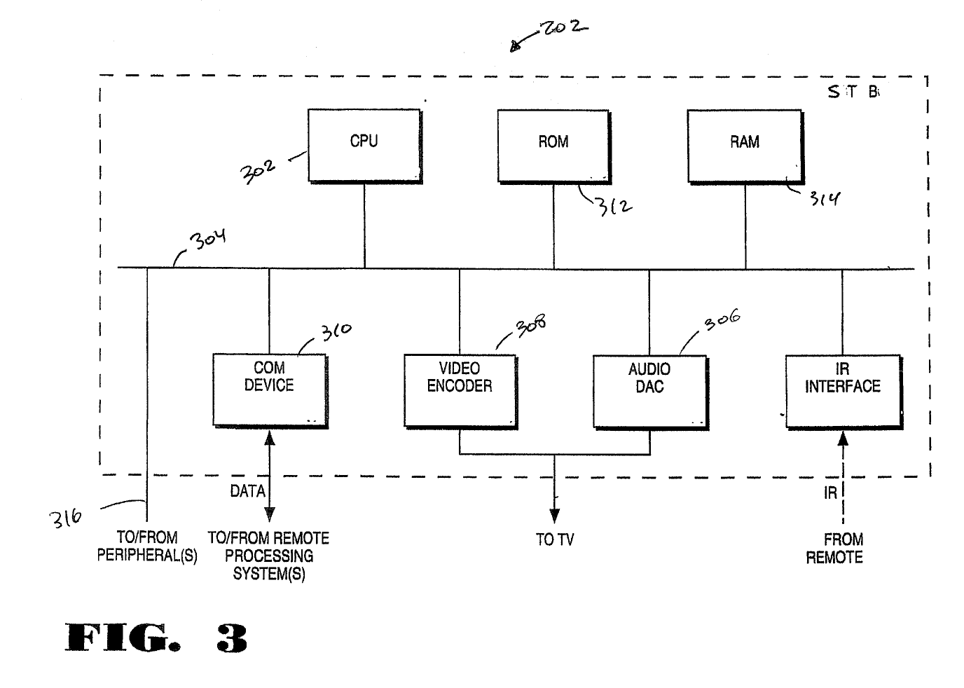

FIG. 3 illustrates exemplary internal components of a conventional MSTV STB 202, in which the client system is controlled by a central processing unit (CPU) 302 which is coupled to a bus 304. In accordance with known computer practice, functions described herein as being performed by the STB 202 (and by the invention) may result from the CPU 302 of the STB 202 executing software instructions, from operation of hardwired circuitry, or both. It will also be recognized that the bus 304 may represent multiple physical buses connected by various bridges and/or adapters, the details of which are not required for an understanding of the present invention. Also in accordance with conventional practice, an audio converter 306 (for providing audio output to the television) and video encoder 308 (for providing video output to the television set) are connected to the bus 304. A communications device 310 (such as a cable modem) is connected to the bus 304 to provide bidirectional data communication with the remote server or servers (102, 106 of FIG. 1) via the Internet. ROM 312 and RAM 314 are also connected to the bus 304, as is an expansion bus 316 that can be used to connect various peripheral devices to the STB 202. The STB 202 thereby functions as the host device of a processing system. Peripheral devices that can be connected to the STB 202 via the expansion bus 316 include, but are not limited to, printers, CD-ROMs or other mass storage devices, microphones, video cameras, video tuners, input devices such as joysticks or mice, and other data communication devices.

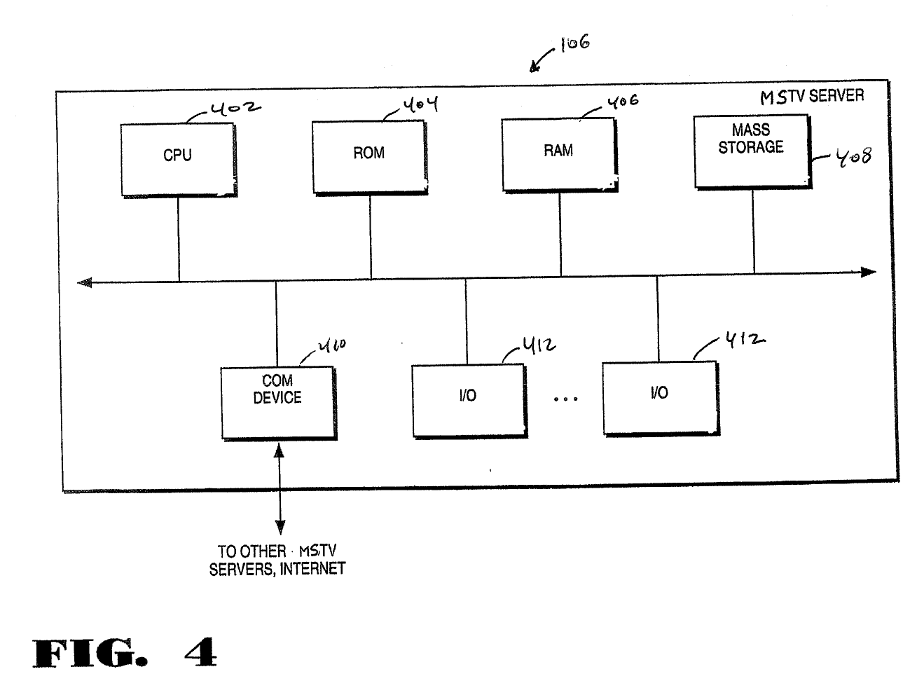

FIG. 4 illustrates an exemplary architecture of a conventional MSTV server 106, which includes a CPU 402, ROM 404, RAM 406, a mass storage module 408, a communication module 410, and various input/output (I/O) devices 412.

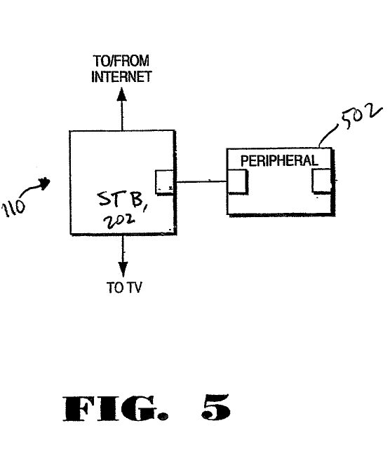

Similarly, FIG. 5 illustrates a conventional MSTV client system 110 (including STB 202) connected to one or more peripheral devices 502 in accordance with known MSTV/STB practice.

### Section II: Functional Description

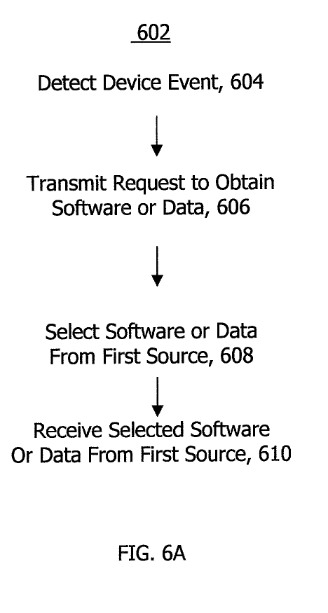

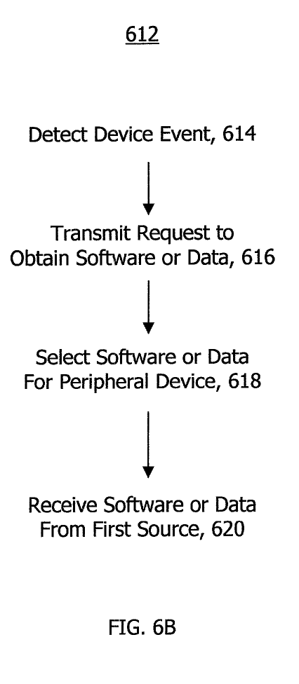

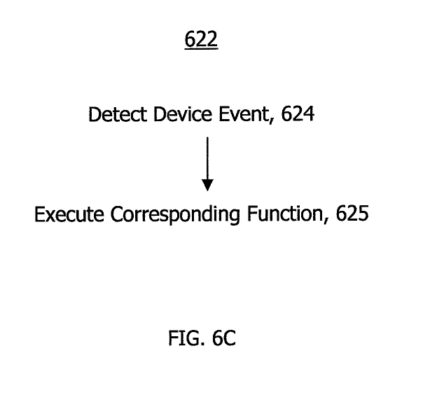

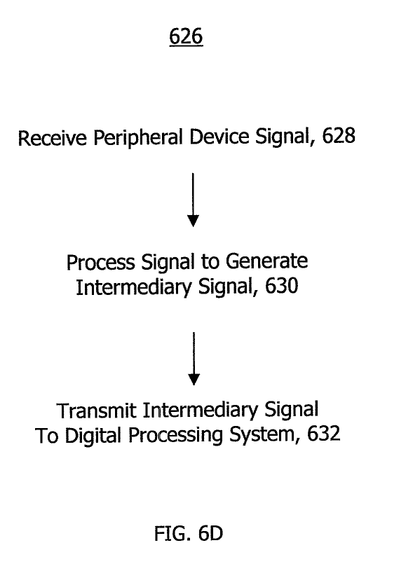

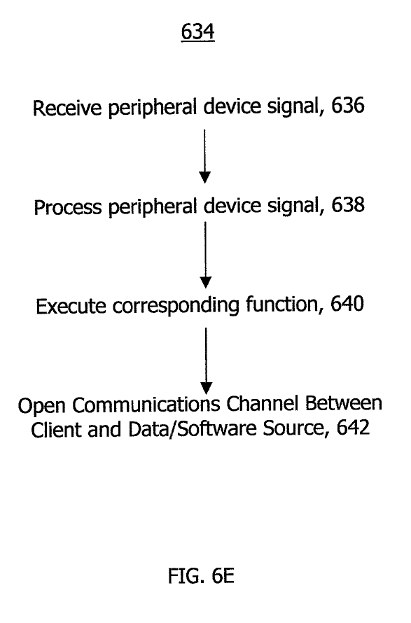

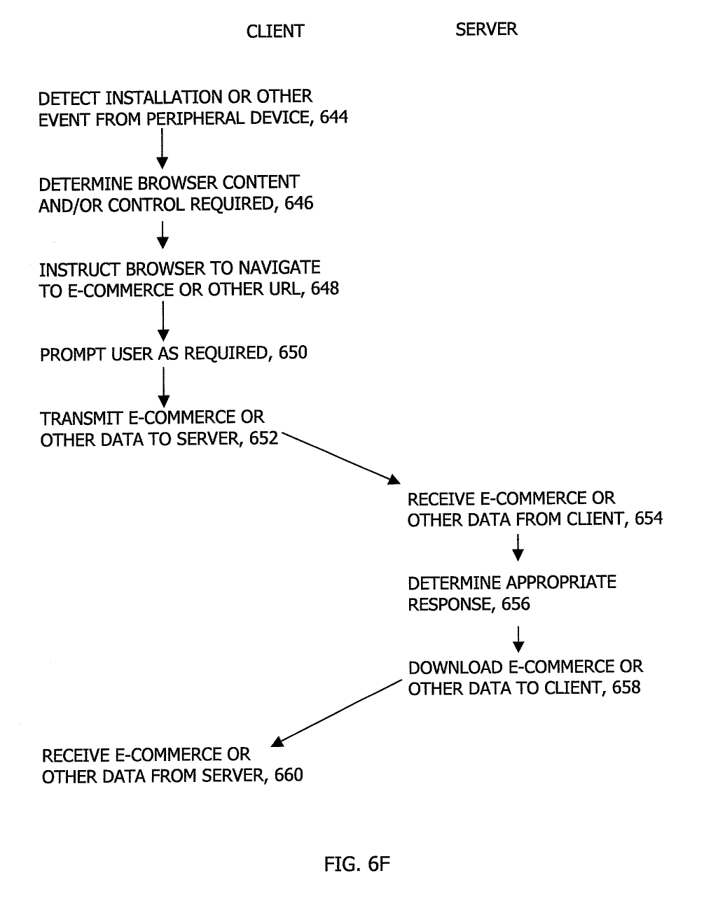

FIGS. 6A-6F depict methods of the present invention, which can be employed in systems such as those depicted in FIGS. 1-5, to advantageously provide additional functionality for such systems. Referring now to FIG. 6A, a method or software process 602 according to the invention invokes the retrieval of software or data from a first source (such as server 106 of FIG. 1, or a local source) to a peripheral device (such as a printer, digital camera, or other peripheral device 502 of FIG. 5). The illustrated method 602 includes detecting a device event generated by the peripheral device (step 604), transmitting to the first source, in response to detection of a device event, a request to obtain the software or data from the first source (step 606), selecting software or data from the first source appropriate for the peripheral device in response to the event generated by the peripheral device (step 608), and receiving the selected software or data from the first source (step 610). As described in greater detail below, the detecting, transmitting, selecting and receiving (604, 606, 608, 610) can be performed automatically when a device event is detected, without intervention by the user of the peripheral device.

An alternative practice of the invention is depicted in FIG. 6B, which illustrates a method 612 of responding to device events generated by a peripheral device. The illustrated method includes detecting a device event (step 614) generated by the peripheral device when it is in communication with an STB or other client system. In response to detection step 614, the process transmits, from the client system to a first source of software or data, a request to obtain software or data (step 616). In response to the request, software or data appropriate for the peripheral device (as defined by characteristics of the detected event) are selected (step 618), and the selected software or data are received from the first source (step 620).

As in the method of FIG. 6A, these operations can be performed automatically (using the software and system architecture described in detail in the following sections) when a device event is detected, without intervention by a user of the peripheral device, and can be executed even when the client system contains no device driver to support the peripheral device. The device events can be generated at peripheral device detection time, during device operation, at device power-up, power-down or disconnect, or at client system power-up.

Another practice of the invention is depicted in FIG. 6C. The illustrated method (622) of responding to events generated by a peripheral device in communication with a client system, includes detecting an event generated by the peripheral device (step 624), and responding to the event generated by the peripheral device by executing a corresponding function, without intervention by the user of the client system (step 625).

FIG. 6D depicts a server-based method (626) of providing a configurable intermediary between a client device and a digital processing system. In a manner analogous to the aspects described above and in the following discussion, method 626 includes receiving from the client device a peripheral device signal representative of an event generated by a peripheral device connected to the client device (step 628). The peripheral device signal is then processed (as described in greater detail below) to generate an intermediary signal (step 630), which has a selectable, standardized format capable of being understood by the digital processing system. The intermediary signal is then transmitted to the digital processing system at step 632.

FIG. 6E depicts another server-based process 634 in accordance with the invention —a method of employing a configurable intermediary between a client system and a first source of software or data to respond to events generated by a peripheral device connected to the client system. Referring now to FIG. 6E, method 634 begins by receiving from the client system a peripheral device signal representative of an event generated by a peripheral device connected to the client device (step 636). The peripheral device signal is then processed (step 638) to generate an intermediary signal with a selectable, standardized format capable of being understood by the first source. The process then responds (steps 640, 642) to the event generated by the peripheral device, by executing a corresponding function (step 640) without intervention by a user of the client system. The function is executed (step 640) with reference to software or data obtained from the first source in response to receipt of the intermediary signal. In the illustrated method, in response to receipt of the intermediary signal the process opens a communications channel (step 642) between the client system and the source of data or software, to enable access to libraries, packages or configuration data on the source, to thereby establish a repository of device drivers and supporting applications suitable for the peripheral device.

Referring now to FIG. 6F, there is shown an e-commerce method in accordance with the invention. In the illustrated process, the client device detects installation or another event from a peripheral device (step 644). It then determines browser content or control required to respond to the event (step 646) and instructs the browser to navigate to an e-commerce site or other URL (step 648). Next, the client prompts the user of the client device as required to obtain data or control (step 650) and transmits e-commerce or other data to the server (step 652). In turn, the server receives the e-commerce or other data from the client (step 654), determines an appropriate response, based on the data (step 656), and transmits responsive e-commerce or other data to the client (step 658). Finally, the client receives from the server the responsive e-commerce or other data (step 660).

### Section III. Client Architecture

This section describes an exemplary architecture of PIA, a software application designed to better enable peripheral devices connected to STBs. Each component of PIA is described in detail, including the overall operation of each component, external interfaces and the communications mechanisms used between components. The embodiments described in this section are capable of interaction with, and utilization of, commercially available Windows CE architecture, sold by Microsoft Corporation, Redmond, Wash., in conjunction with Microsoft's Microsoft TV Advanced and the Microsoft TV Advanced Browser. Additional description of Microsoft TV Advanced and Microsoft TV Advanced Browser is publicly available in documents published by Microsoft Corporation, the teachings of which are incorporated herein by reference.

A central, though by no means the only, objective of the PIA system of the invention is to provide a better user experience for connecting peripherals to set top boxes (STBs). The PIA system described herein will automatically update the system to support newly installed devices and will invoke software clients in response to “events” generated by the device. PIA does not limit the type of peripherals that it will support, but is well suited to support devices that are dynamically inserted. PIA will support devices located on any bus, as long as a knowledgeable bus enumerator exists for that bus, in accordance with known bus practice.

The PIA system will respond to events generated in the system to carry out a desired function. The events generated in a given system are flexible, based upon their definition for that system. Generic device class events can be defined, as can device-specific events. Events may have static, dynamic and/or device-specific data associated with them. Events can be generated from any source, although typically device drivers and bus enumerators will be generating most events.

For example, upon the insertion of a new device, the bus enumerator which manages that bus or device would generate an ‘INSTALL’ event. Upon receipt of the ‘INSTALL’ event, PIA could contact a server to install the necessary drivers to support the device. Additionally, once the installation is complete, PIA could communicate with the browser to navigate to an e-commerce site appropriate for the newly installed device. The devices, events and responses are defined in a platform-specific database, as further described below.

1 PIA Architecture Overview

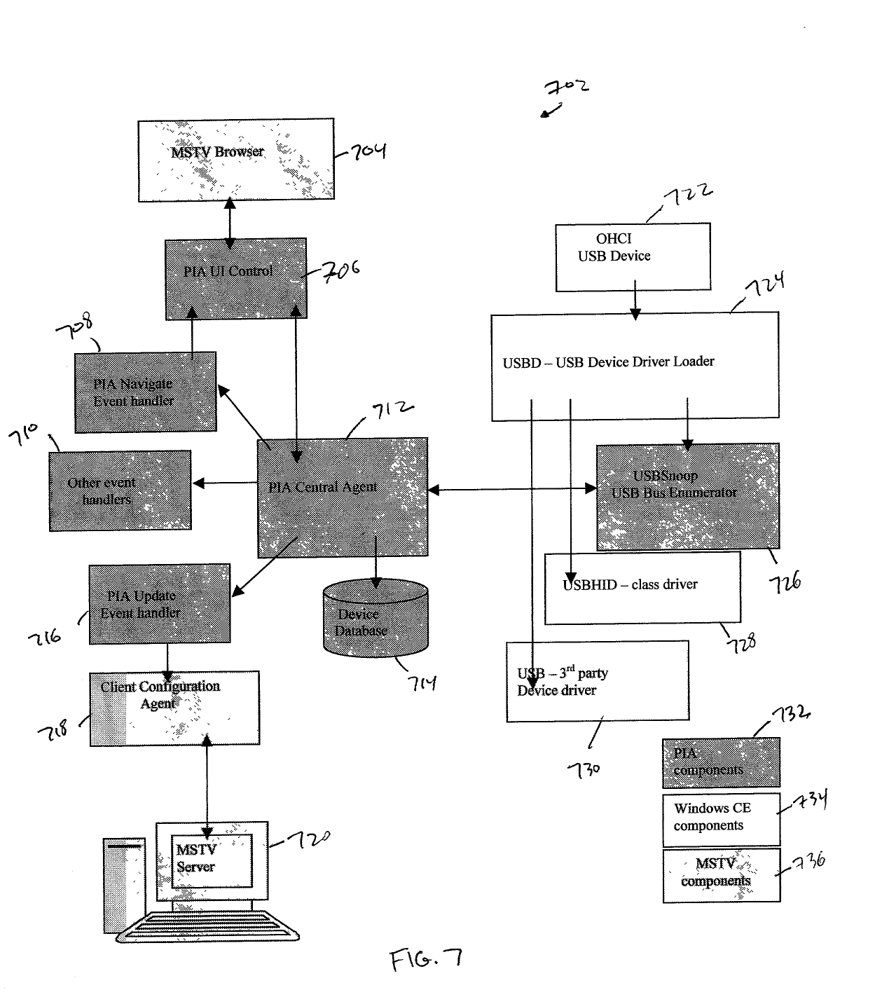

The architecture of PIA involves several components. FIG. 7 shows an example of the components in PIA including a USB bus enumerator 726. FIG. 7 is provided by way of example, and the structures shown may be changed, based upon the PIA-knowledgeable components present in a given system. As FIG. 7 illustrates, one embodiment of the PIA invention utilizes Microsoft TV Advanced components 736 and Windows CE components 734. The interactions of the elements shown in FIG. 7 will be discussed in greater detail below.

Microsoft TV Advanced is one, though by no means the only, environment for implementation of PIA. One objective of Microsoft TV Advanced is to address the needs of users who are less computer-knowledgeable than the average PC user. PIA supports this mission, by enabling Microsoft TV Advanced to dynamically add support for new peripherals without user intervention in the typical case.

In addition, Microsoft TV Advanced supports field updates of the operating system, but does not address the need to add dynamic device support in the field. PIA adds this ability, by exploiting an Microsoft TV Advanced component on the client set top box known as the Client Configuration Agent (CCA) 718 of FIG. 7. As described below, CCA 718 is an agent that communicates with a Client Configuration Server (or CCS, part of the Microsoft TV Advanced Server) to obtain software updates in the field.

PIA also provides additional functionality through communications with the Microsoft TV Advanced Browser 704 of FIG. 7, as described in detail below. For example, the browser can be directed to navigate to a specific Web site that is appropriate for a device that has just been inserted. In addition, PIA can provide information to the Microsoft TV Advanced Server 720 of FIG. 7, that enables it to respond with targeted content. These ease-of-use features are a basic design goal of PIA, which the system achieves, in one embodiment, through interaction with the Microsoft TV Advanced infrastructure.

1.1 PIA Component Overview

The PIA architecture described herein has been designed to be flexible in its operations and easily enhanced by the addition of new components. PIA components can be customized by STB OEMs (original equipment manufacturers), peripheral vendors and/or network operators.

One category of components that may be added or enhanced are bus enumerators (see, e.g., 726 of FIG. 7). PIA can include various bus enumerators, including a USB bus enumerator (USBSNOOP) and a 1394 bus enumerator. These bus enumerator elements are responsible for detecting devices on the bus and determining whether the proper device driver support exists to manage the new device. If not, a PIA enhanced bus enumerator could generate an ‘INSTALL’ event to have the necessary device drivers retrieved and installed on the client, without user intervention.

Device drivers (e.g., 3rd-party device drivers 730 of FIG. 7) are another category of component that may benefit from PIA enhancements. Although this is not generally required, some peripherals may require attention during operation. An example is a printer running low on ink or out of paper. A device driver that is PIA-aware could generate a ‘low ink’ event that results in a navigation to an e-commerce site to order ink cartridges specifically for that printer.

Both device drivers (e.g., 730 of FIG. 7) and bus enumerators (e.g., 726 of FIG. 7) are considered clients of PIA. They make requests of PIA (by generating an event) and may expect some type of response.

A further category of components that may be added are called event handlers (e.g., PIA navigate event handler 708, PIA update event handler 716, and other event handlers 710, each of which is shown in communication with PIA Central Agent 712 in FIG. 7). In this practice of the invention, event handlers are not intended to be clients of PIA. Rather, they extend the system's capabilities by carrying out the functionality that corresponds to the events generated. For example, PIA can provide an ‘UPDATES’ event handler that responds to the ‘INSTALL’ event by retrieving new software and installing it on the client.

Thus, in the embodiment shown in FIG. 7, PIA includes a single main component that manages all the clients and event handlers. This is called the Central Agent 712. The Central Agent is the focal point for the interaction that occurs between components. As shown in FIG. 7, the Central Agent 712 is in communications with device database 714, PIA update event handler 716, client configuration agent (CCA) 718, MSTV server 720, PIA navigate event handler 708, other event handlers 710, PIA UI control 706, MSTV browser 704, USBSnoop/USB bus enumerator 726, USBHID class driver 728, USB 3rd-party device drivers 730, USBD-USB device driver loader 724.

The structure, function, and interaction of each of these elements will next be discussed.

1.2 Operational Flow

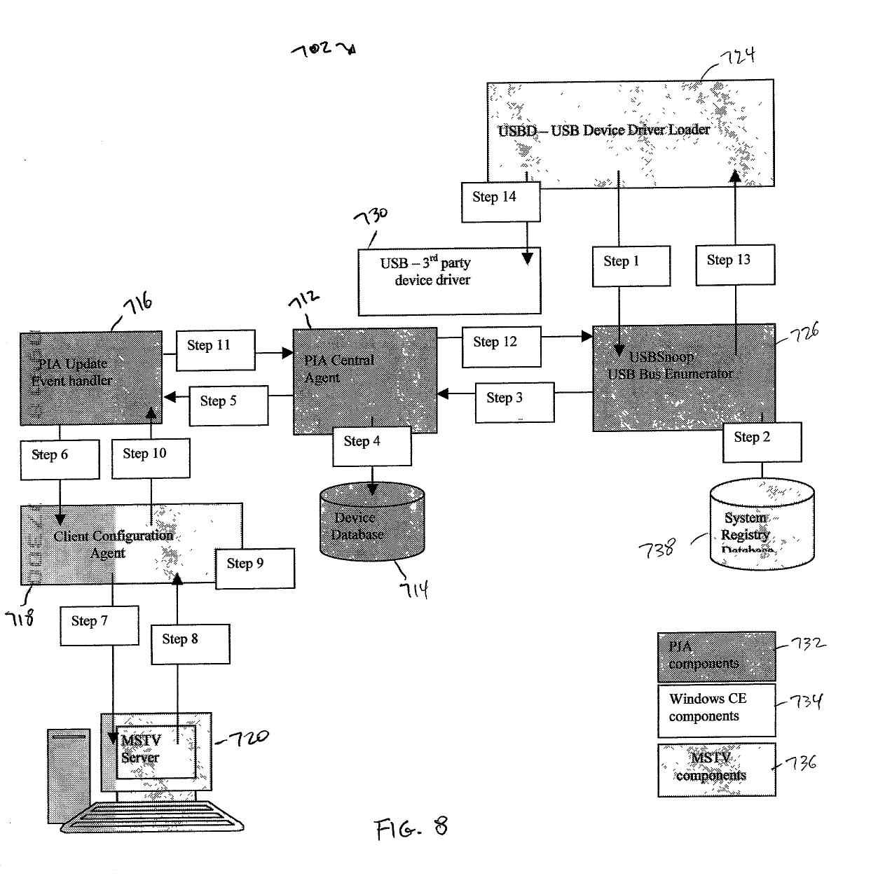

The following discussion describes the processing flow through the components in the FIG. 7 embodiment of the PIA invention, with reference to FIG. 8 and its illustrated example of the processing that occurs when an event is generated. Referring now to FIG. 8, we examine what occurs when a newly discovered (i.e., never-before configured) USB device is plugged into the STB. The following steps occur (each depicted in FIG. 8 with the corresponding step number):

1. USBD 724 detects a new device on the bus. Its responsibility is to load the driver that corresponds to the new device. To do this, it first calls USBSnoop 726.

2. USBSnoop 726, using the device information, checks the list of USB drivers (e.g. in system registry database 738) to determine if a device driver is present on the client to support the new device.

3. USBSnoop 726 determines that there is no existing device support. It generates an ‘INSTALL’ event by calling the PIA Central Agent 712.

4. The PIA Central Agent 712 looks up the device and event information (passed to it by USBSnoop 726) in its database 714 to determine if it can process the event requested.

5. The PIA Central Agent 712 finds that it has an event handler (PIA Update event handler 716) capable of processing the ‘INSTALL’ event. It loads the event handler and passes the install request to the event handler. Data is passed with this request so the event handler can identify the component needing to be installed.

6. The event handler 716 contacts the client configuration agent 718 (in this example, CCA is a part of the known Microsoft TV Advanced Client) to request retrieval and installation of the component.

7. The client configuration agent 718 establishes a connection to the client configuration server (in this example, part of the known Microsoft TV Advanced Server 720) and requests the download of the component.

8. The client configuration server responds to the client configuration agent 718 by allowing the download of the component.

9. Once the download is complete, the client configuration agent 718 processes the component by installing it into the proper location on the STB (e.g., 202 of FIGS. 2 and 3). This may include registry entries and other supporting modules in accordance with known STB techniques.

10. The client configuration agent 718 returns control to the event handler 716 with a successful installation response.

11. The event handler 716 returns control to the PIA Central Agent 712 with a successful installation response.

12. The PIA Central Agent 712 returns control to USBSnoop 726 with a successful installation response.

13. USBSnoop 726 returns control to the USBD 724, informing it to continue to look for a driver to support the new device.

14. USBD 724 finds the newly installed driver in the list of supported drivers and loads it to manage the new device.

The foregoing is an example of how synchronous events can be defined and carried out through PIA. The update case may be somewhat more complex, in that it is carried out as an asynchronous event. Accordingly, when the Central Agent 712 determines that it can execute the request (Step 4), it spawns a thread to proceed with the install (Step 5), and returns the main thread back to the caller. The response to the caller (Step 12) then occurs through a callback mechanism. The use of threads and callback mechanisms is well known in the art, and those skilled in the art will appreciate how to implement them in the context of the present invention.

1.3 PIA Database Overview

In the illustrated embodiments, the PIA system relies upon a database of information to provide the instructions required to perform event handling. This database describes the devices and events supported by PIA in the STB. In one practice of the invention, the database is contained in an XML file that resides on the client system. As described below, the database can be updated periodically from the server to extend the list of supported devices, events and/or responses.

In this example, the database is comprised of two object trees, i.e., an event object tree and a device object tree. The event object tree contains a list of event handlers. These event handlers are responsible for carrying out the request made when a PIA client generates an event. Information in the event tree is generic in nature (no device specific or context information is defined in this object tree) and simply contains a series of XML objects that identify the events each event handler is capable of carrying out. Optionally, an event handler can be categorized as an asynchronous event handler if that handler performs potentially lengthy processing.

Also in this example, the device object tree contains a list of devices. Devices can be specific or general (e.g., Lexmark Z12 printer, or USB printers). The general case can be used to categorize classes of devices. Each device object contains a number of elements that identify the device (or device class) and identify the events that the device could generate. A mapping exists between each device/event in the device object tree and an event in the event object tree. This mapping is used to determine which event handler is invoked in response to a generated event for a given device. These device/events (or device class/events) can contain data elements that PIA passes to the event handler. In addition, the data elements can contain substitution parameters.

The combination of device/event objects can be thought of as a mechanism to run scripts. When an event is generated by a certain device, this device/event combination is retrieved from the database along with the event handling instructions (and data elements) that apply to this device/event request, and the request is carried out. If the data elements contain substitution parameters, these parameters are replaced in line with the associated run time data. For example: A ‘NAVIGATE’ event handler has a data element associated with it that is the URL to navigate to. The unique identifier for the set top box may need to be embedded in the URL to pass along to the server. This can be accomplished by specifying the MACHINE_ID substitution parameter at the location in the URL where this information is needed. Additional information regarding parameters supported and database object and element definitions are set forth below.

1.4 Central Agent Overview

In the illustrated embodiments the Central Agent (712 of FIGS. 7 and 8) is a Stream Interface device driver that provides an IOCTL interface used by its clients to make requests. The Central Agent is responsible for managing the interactions between its clients and event handlers. Clients are defined as any component that makes a request of PIA. This usually consists of bus enumerators and device drivers. The Central Agent's name reflects its role in the system, receiving requests from its clients and passing along these requests to other components, i.e., the event handlers, to carry out the processing, as shown in FIGS. 7 and 8.

Requests are typically made in the form of an event generation, although there are supporting functions that do not result in event generation. For these requests, clients are said to generate an event to PIA. (The term “generating an event” is used instead of “making a request” since the client may not need to know if any processing is carried out as a result of the event generation.) The Central Agent receives the events and, using the information, performs a look up in its database to determine whether event processing must occur in response to the event. If so, the Central Agent retrieves the event handling instructions and locates the specified event handler defined in the database. It will load the event handler and issue the request to the handler in response to the event. In this example of the invention, the Central Agent is not knowledgeable about specific events, but treats them in this generic fashion, performing a lookup in its database and carrying out the desired functionality. In this way, the list of devices and events that the Central Agent can support is unrestricted.

In addition, the Central Agent's event mechanism is extensible. As noted above, the database can be updated periodically to enable this extensibility. The Central Agent maintains no knowledge of event handlers in the system, so if an update occurs to the database adding more event objects (and thus more event handlers), the Central Agent will automatically make use of those new handlers when an event is received that corresponds to them.

In addition to handling requests from its clients, the Central Agent may need to initiate communication to its clients. When a client has generated an asynchronous event (as specified in the event object tree), the client may be notified, with the results, once that event processing has been completed or failed. Clients also may need to be notified of system events. The Central Agent can utilize either of two methods to initiate communication with its clients for such notifications. The client chooses the method the Central Agent uses for notification, by registering with the Central Agent and passing its notification mechanism. The first method is in the form of a registered callback. Clients running in the same process space as the Central Agent may choose this method. In the second method, the Central Agent signals a client-owned event object. This approach is used primarily by clients running in a different process space, since a direct callback is not possible in such instances. When a client is signaled through its event object, the client responds by calling a specific IOCTL in the Central Agent to retrieve the data that describes the reason for the notification. With either mechanism, it is up to the client to determine the type of notification that occurred and carry out any needed processing, or ignore the notification.

The Central Agent is also responsible for managing the packages (described in greater detail below) that it installs on the client STB. Since STBs are generally resource constrained, the Agent will support drivers that are installed on a temporary basis. When the driver is not in use, it may be removed from the system. However, the Central Agent will track the fact that the device was configured on the system so the next time it is installed, it will not appear to the user to be a first time installation. This is significant because PIA allows processing based upon device events, and it would be efficient for certain peripherals to distinguish between a first time installation (and its associated event behavior) and subsequent enumerations (or installs) of the same device. The driver or software components may also contain run time settings that persist even if the software is installed on a temporary basis. Additional detail regarding temporary device driver support is set forth below.

1.5 Events and Event Handlers Overview

As described in greater detail below, events are defined in an XML database. Events can be generic, or device-specific. The database is extensible, so that event support can be added over time as new functionality is required.

The function of the event handlers is to carry out specified processing in response to a generated event. The Central Agent does not perform event processing on its own, but invokes event handlers that, in turn, carry out the processing.

In the illustrated examples, all event handlers support at least one class of event, and within an event class they can support multiple event types. An example of this is the PIA Update event handler. This handler supports the ‘UPDATES’ event class. Within this class, two event types are specified, the ‘INSTALL’ event type and the ‘REMOVE’ event type. Event handlers can also support multiple event classes, and event types within each class, if needed.

When PIA clients generate events, they call a driver specific IOCTL in the Central Agent, passing it the event type and device identifier. The event type for this device identifier maps to an event class in the database. This event class is used by the Central Agent to load the appropriate event handler. When an event class is determined, its CLSID is used by the Central Agent to instantiate it. All communication to event handlers is initiated by the Central Agent in response to an event generation. The Central Agent communicates to event handlers through a COM interface, known as IPIADevEvent, described below.

1.6 Bus Enumerators Overview

Bus enumerators (e.g. 726 of FIGS. 7 and 8) are primarily responsible for detecting the addition and removal of devices on their bus. The illustrated examples of PIA use bus enumerators to determine whether proper device support is available as peripheral devices are dynamically plugged in to an STB or other client. PIA supplies the USBSnoop component, a bus enumerator for the USB stack. Its purpose is to identify a device that has just been plugged in, and determine whether a device driver exists on the client STB that can manage the device. If it cannot find a device driver that manages the device, it will generate an ‘INSTALL’ event to the Central Agent. In particular, it generates an ‘INSTALL’ event (or any PIA event) by calling the IOCTL interface in the Central Agent. If the Central Agent supports the device, it will go through the necessary steps to locate and install the drivers and associated data. USBSnoop will wait for the completion of the ‘INSTALL’ event to determine whether proper support now exists on the STB for the new device. If so, it will continue its normal processing that will result in the appropriate device driver being loaded.

In the illustrated examples, bus enumerators are not restricted to generating only ‘INSTALL’ events. Bus enumerators may also generate other events useful for the bus they manage. Other examples of common events are ‘REMOVE’ and ‘ENUMERATE’ events. On STBs that are particularly resource constrained, ‘REMOVE’ events can be used to unload drivers that have been temporarily loaded into RAM (through an ‘INSTALL’ event) due to a lack of persistent storage. It may also be desirable to perform some event handling when a device is plugged in that is not new to a system. In that case, an ‘ENUMERATE’ event could be used. Adding ‘ENUMERATE’ events to a bus enumerator is a quicker task then adding ‘ENUMERATE’ events to all the device drivers that an enumerator manages in a system.

1.7 Device Drivers Overview

Printers and other peripheral devices may require attention while running. A printer may be run low on ink, or run out of paper. In such cases it would be useful to notify the user that the event is occurring, so they can obtain more supplies for their printer or other peripheral. The PIA significantly expands upon this possibility. For example, in addition to simply generating (on the user's TV) a message box alerting the user to the condition, the PIA could automatically inform the associated browser 704 (FIG. 7) to navigate to a web site for purchasing printer supplies. It could also pass up device information that could be used by the web site to provide targeted content, offering to the user supplies specific to their printer. Another application is the all-too-familiar paper jam. The driver could generate a “paper jam” event that results in the playing of a FLASH movie explaining to the user how to open to printer and clear the stoppage.

Device drivers would generate these events in the same way that the bus enumerators do, by calling the IOCTL interface in the Central Agent. The universe of events that the Central Agent supports for a given device is determined by the contents of the database, and thus can be defined for an individual device driver as needed. The device driver simply generates the event to the Central Agent, and is unaware of how the response is carried out. All interfacing to the event handlers to process an event is carried out by the Central Agent.

1.8 PIA UI Control Overview

In the examples described in this document, the PIA UI Control is an ActiveX control that provides a linkage between the PIA event architecture and the browser. The PIA UI Control can performs a variety of functions. First, the PIA UI Control is loaded in an HTML page when the browser is executed. When this occurs, the Control is responsible for signaling an event to the Central Agent so the Agent is aware that the boot process has completed. This enables PIA clients to receive system notifications from the Central Agent when the boot cycle completes. This process is further described in the POST BOOT EVENT section below. Second, the PIAUI Control directs the browser to navigate to a specific URL in response to a device event. In this case, the PIA UI Control is an extension of the NAVIGATE event handler, also described below.

2 PIA Central Agent

In the examples described herein, the Central Agent is a DLL (Dynamic Link Library) with the following responsibilities:

Act upon events generated from its clients and perform the requested function via another component;

Manage the local database of events and devices—this includes handling updates of objects when a subset of the database is updated from the server;

Provide callers with information regarding support for events and devices;

Perform clean up of temporary drivers if configured for clean up;

Maintains a database of registered clients to enable callbacks and notifications to occur;

Performs notifications of system events to its registered clients; and

Maintain registry entries for all devices for which it receives event requests. These PIA devices may contain additional information from or for other PIA components.

The Central Agent exists in the context of the familiar (in the Microsoft Windows CE environment) DEVICE.EXE. Most drivers also run in this context. (Not all do, however. For example, the 1394 driver stack runs in the WDMDevice context.) In order to support clients running in different processes, the system utilizes an IOCTL interface. While most of the Central Agent's clients are drivers, this is not a requirement or limitation, and clients can include ActiveX controls and other applications.

Clients can communicate and register with the Central Agent primarily through its IOCTL interface. The Central Agent maintains a list of registered clients, and in order for a client to receive notifications, whether through a registered callback or by signally a client-owned event object as described above, the client must register with the Central Agent.

Additionally, the Agent communicates with a special ActiveX control to provide support into the Browser. This UI Control exists in the Browser context and also makes requests of the agent through the IOCTL interface. Since the UI Control carries out browser requests on behalf of the agent, the communication between these entities is more tightly coupled, as described below.

2.1 Central Agent Initialization

In the examples discussed herein, the Central Agent is loaded by device.exe early in the boot process. However, the Central Agent may not be able to carry out many of the device events early in the boot process. For example, a request for software update requires a functioning TCP/IP stack. This requires that most drivers be loaded. Additionally, requests for browser navigation cannot occur until the browser is known to be running. To manage the timing of the boot process, the Central Agent is notified when the browser first runs. This notification is performed by the PIA UI Control, as described in further detail below. Once the Central Agent receives the notification, it is able to notify its registered clients of the event (either through a direct callback or through their event objects), to allow them to perform any requests they could not carry out earlier in the boot process. Further details of this event notification are provided below.

The Central Agent maintains a list of devices (‘PIADevices’) in the system registry. In particular, an entry for each device defined in the PIA database, for which the Central Agent receives an event, is maintained in this registry list. These entries are expected to persist across boots. During its initialization, the Central Agent enumerates the PIADevices sub-tree and updates each device's DeviceFlags entry (described in detail below in the Registry Usage section) to specify that the device is not currently configured. This is used to help the Central Agent track the usage of software, to manage the temporary installation of these packages. When devices are subsequently configured, the Central Agent then updates the device's DeviceFlags to indicate that device configuration has occurred (along with the LastAccessed value).

The Central Agent will also perform cleanup of temporary devices on a periodic basis (if enabled in the CAFlags registry entry). It will determine whether support for a device can be removed, and whether the device is not configured but is installed (these settings are contained in the device's DeviceFlags registry entry); and then determine whether the software has expired due to inactivity. The Central Agent determines whether the software has expired by checking the device specific AutoRemove value, or the global AutoRemove value (Central Agent configuration) and comparing that against the device's LastAccessed value, to see whether the period of inactivity has been satisfied. If all these conditions are true, the Central Agent will remove the software package and update the DeviceFlags flag to maintain the current state of the device/software support package. When the device is subsequently plugged in, the Central Agent will know that the device is not being installed for the first time, but that the package needs to be re-installed.

In addition to periodic cleanup, the Central Agent can also perform cleanup on demand. This capability exists to handle the case when a new package installation is needed, but the storage capacity is not available on the STB. In this case, if the Central Agent could not free up sufficient capacity through expired software, it would use an LRU (least recently used) algorithm to determine which packages have had the longest period of inactivity, and remove those.

The Central Agent must load its XML master database before it can process any IOCTL requests. This is not done at driver initialization time, since the necessary system resources may not yet be available. Upon receiving an IOCTL (or subsequent IOCTLs if necessary), the Central Agent retrieves the location of the XML master database from the registry. The Agent then reads and parses the XML to create the object trees. If the Central Agent is successful at parsing the master XML database, the Agent then enumerates the PIADevices subtree in the system registry and updates the XML object tree in memory to add or update any device specific changes. When the Central Agent gets subsequent IOCTL requests, the Agent checks to see if the Master XML database has been updated since it loaded it. If so, the Agent deletes the object hierarchy and re-processes the Master XML database and any device specific updates.

2.2 Central Agent IOCTL Interface—Syntax and Examples

As previously noted, the Central Agent provides communication through an IOCTL interface. In the examples discussed herein, clients that wish to communicate to the Central Agent call CreateFile for the PIA1: device and perform the desired IOCTL function. This section describes IOCTL calls that the Central Agent supports in one practice of the invention. (Other formats can be utilized, and within the scope of the present invention.) In the present examples, all calls follow the same format, and are made via the DeviceIoControl call made into the kernel. Additional details of this call format are set forth in the Windows CE Platform Builder documentation publicly available from Microsoft Corporation, Redmond, Wash., the teachings of which are incorporated in their entirety herein by reference. The format of DeviceIoControl is:

BOOL DeviceIoControl(HANDLE hDevice, DWORD dwloControlCode, LPVOID IpInBuffer, DWORD nInBufferSize, LPVOID IpOutBuffer, DWORD nOutBufferSize, LP DWORD IpBytesReturned, LPOVERLAPPED, IpOverlapped);

hDevice—handle to the device returned from the CreateFile call.

IpOverlapped—set to NULL

Return Values —All calls return non-zero for success and zero for failure. In the case of failure, the error code is retrieved with GetLastError. These error codes are described in the specific IOCTL definitions where applicable.

The definitions for the other parameters for this call will vary based upon the IOCTL call being made. The following discussion details the PIA-specific device IOCTLs and the IOCTL-specific parameters.

2.2.1 PIA_IOCTL_REGISTER_EVENT_NOTIFICATION

As noted above, each caller registers its callback address or event object with the Central Agent. Clients that register for notification include any callers that generate asynchronous device events to the Central Agent, and/or clients that are interested in system events. These typically include bus enumerators and device drivers. The following mechanism are employed:

dwloControlCode—IOCTL function code is PIA_IOCTL_REGISTER_EVENT_NOTIFICATION

IpInBuffer—Points to a PIARegistrationRequest packet

PIARegistrationRequest packet

| | |
|---|---|
| PIA_CALLBACK | *pfnCallback |
| HANDLE | hNotifyEvent |
| LPVOID | pUserData |

pfnCallback—Client callback function to receive event results and system event notifications—the definition of PIA_CALLBACK is described below in the discussion of 2.3 PIA Client Notification and System Events. This mechanism is used for clients running within the device.exe process.

hNotifyEvent—Handle to the client-owned event notification object, if this is non-NULL, the event object will be signaled instead of executing the callback handler. This mechanism is used for clients not running in the device.exe process. However, clients running in the device.exe process may use this method if desired.

pUserData—Caller's data that is passed back to the caller in the callback handler in the PIACallbackPkt packet. This may be used to enable the client to receive a pointer to its context data.

nInBufferSize—Size of the PIARegistrationRequest packet

IpOutBuffer—If successful, points to an identifier used by the agent to identify this caller.

nOutBufferSize—sizeof (DWORD)

lpBytesReturned—sizeof (DWORD)

Error Codes

ERROR_INVALID_PARAMETER if both pfnCallback and hNotifyEvent are specified or if neither one is specified. ERROR_NOT_ENOUGH_MEMORY if memory cannot be allocated to track this client.

Remarks

The Central Agent tracks this data per client, generating a unique ID that it uses to refer to this caller. If a callback handler is specified, the callback handler is invoked when the Agent has a system event to broadcast, or upon completion of an asynchronous event request from the caller. The callback should be accessible for the duration of the registration. If the event object is specified, the object is set to the signaled state when the Agent has a system event to broadcast or upon completion of an asynchronous event request from the caller. If the client receives its notification through the event object, the client should then perform the PIA_IOCTL_GET_EVENT_RESULTS IOCTL to obtain the details of the notification.

2.2.2 PIA_IOCTL_DEREGISTER_EVENT_NOTIFICATION

The caller de-registers its callback mechanism with the central agent.

dwloControlCode—IOCTL function code is

PIA_IOCTL_DEREGISTER_EVENT_NOTIFICATION

IpInBuffer—Points to agent generated identifier for this caller

nInBufferSize—sizeof (DWORD)

IpOutBuffer—NULL

nOutBufferSize—0

lpBytesReturned—NULL

Error Codes

ERROR_INVALID_PARAMETER if the agent cannot find the identifier for this caller in its internal list

Remarks

The Central Agent performs a lookup of the caller and removes the caller from the list of registered clients. Once the de-registration process occurs, the Central Agent will no longer attempt to contact the caller for any events.

2.2.3 PIA_IOCTL_QUERY DEVICE_EVENT

This call is used by any client to find out if a specific event is supported for a given device.

dwloControlCode—IOCTL function code is

PIA_IOCTL_QUERY_DEVICE_EVENT

IpInBuffer—Points to the PIAQueryDeviceEvent packet

PIAQueryDeviceEvent packet

| | |
|---|---|
| TCHAR | eventType[32] |
| TCHAR | deviceIdentifier[x] |

eventType—EVENT_TYPE for this device as specified in the device/events XML database (e.g. INSTALL, ENUMERATE; a list of standard eventTypes is set forth below in the 4.2 Standard Event Handlers section).

deviceIdentifier—String that uniquely identifies this device to the central agent—this string is not a fixed size.

nInBufferSize—Size of the PIAQueryDeviceEvent packet and the expanded deviceldentifier string.

IpOutBuffer—NULL

nOutBufferSize—0

lpBytesReturned—NULL

Error Codes

ERROR_DEV_NOT_EXIST if device or device/event combination does not exist

Remarks

The Central Agent will check its database to first determine if the device exists. If the device exists, the specific device sub-tree will be checked for the existence of the specified event. This call is typically generated from bus enumerators to determine whether a channel subscription exists on the server to support this device. In this case, the bus enumerator would query for an ‘INSTALL’ event for the device in question. Some bus enumerators (e.g. USBSnoop) may call this method several times before finding a driver that satisfies the new device.

2.2.4 PIA_IOCTL_DEVICE_EVENT

This call informs the Agent that a specific device event has occurred so the agent can invoke any necessary event processing in response to the event.

dwloControlCode—IOCTL function code is PIA_IOCTL_DEVICE_EVENT

IpInBuffer—points to a PIADeviceEvent packet

PIADeviceEvent packet

| | |
|---|---|
| DWORD | dwClientID |
| TCHAR | eventType[32] |
| TCHAR* | deviceIdentifier |
| DWORD | dwEventDataLength |
| LPVOID | eventData |

dwClientID—Unique identifier used by the Agent to identify this caller. This is obtained when the client registers a callback handler or event object. The caller may specify 0 if no notification (upon completion of an asynchronous event) is required.

eventType—String that identifies the event triggered for this device

deviceIdentifier—Pointer to the string that uniquely identifies this device to the central agent

dwEventDataLength—Length of the data pointed to by eventData—0 if eventData is NULL

eventData—Event specific data that is passed to the event handler. Detail is provided below regarding how each event handler determines whether (and how) eventData is used by the handler.

nInBufferSize—Size of the PIADeviceEvent packet

IpOutBuffer—NULL

nOutBufferSize—0

IpBytesReturned—Ignored

Error Codes

ERROR_DEV_NOT_EXIST if the specified device (or event type for this device) does not exist in the database

Remarks

In accordance with the mechanisms noted above, the Central Agent checks its database to determine whether the specified device exists, and then the eventType for the specified device. If true, the Central Agent invokes the event handler that corresponds to this event, passing it the eventData from the PIADeviceEvent packet as well as any argument data specified for this device/event in the XML database. Additionally, the Central Agent will look up the device in the registry and add/update entries for this device as needed, as discussed in further detail below. Also described below are details regarding the mapping of eventType to an event handler, and the manner in which the argument data is specified for a given device or event.

The Central Agent handles event processing in a generic manner, with the exception of the ‘INSTALL’ and ‘REMOVE’ events. When the Central Agent receives a request for an ‘INSTALL’ of a device, the Agent awaits successful completion of the device event handler and reads the registry entries for this device. If a PIADeviceData value exists in the device specific key, the Central Agent will read the XML file specified in PIADeviceData and update the XML master database. When a ‘REMOVE’ request is made, the Agent retrieves any device specific XML entries specified in the PIADeviceData file, and removes them from the master XML database.

2.2.5 PIA_IOCTL_GET_EVENT_RESULTS

This call is made by a client to retrieve the results of an asynchronous device event request or system event information from the Agent. The client will perform this call when its registered event notification object has been set to the signaled state. Clients using the callback method of notification will not need to perform this call, since this data is passed directly to the callback handler.

dwloControlCode—IOCTL function code is

PIA_IOCTL_GET_EVENT_RESULTS

IpInBuffer—Points to agent generated identifier for this caller

nInBufferSize—sizeof (DWORD)

IpOutBuffer—Pointer to the buffer that receives the pending event specific results, see the section on 2.3 PLA Client Notification and System Events for the packet descriptions.

nOutBufferSize—Size of the 1pOutBuffer—the format and size of this buffer will vary based upon the type of event results received

lpBytesReturned—If the results are placed in the 1pOutBuffer this size of the data is returned here

Error Codes

ERROR_INVALID_USER_BUFFER if the output buffer is not large enough to contain the data, in this case 1pBytesRetumed specifies the size needed

Remarks

The Central Agent maintains a link list of event results for those clients that use the notification object as their method of notification. (Clients using the callback method receive the data directly through their callback handler.) The Agent checks its list of registered clients, removes the first entry in the list of event results for this client and updates the IpOutBuffer with those results.

2.3 PIA Client Notification and System Events

As noted above, the Central Agent must communicate with its clients. For example, when a client has requested an asynchronous event (determined by the EVENT_CLASS for the event the client is requesting), the client may be notified with the results, once that request has been completed or failed. The client may also require notification of certain system events. The Central Agent initiates communication with its clients for these events, using either of two methods selected by the client when the client calls PIA_IOCTL_REGISTER_EVENT_NOTIFICATION. The first method is a registered callback. Clients that are running under device.exe may choose to register a callback entry point for notifications. The syntax for the callback handler is:

void PIACallback (LPPIACallbackPkt lpPIACallbackPkt);

lpPIACallbackPkt—Contains a pointer to the PIACallbackPkt structure

PIACallbackPkt packet—Minimally contains:

| | |
|---|---|
| LPVOID | pUserData |
| BOOL | bSuccess |
| TCHAR | eventType[32] |
| TCHAR* | deviceIdentifier |

pUserData—Contains a pointer to the caller's context data

bSuccess—Success or failure it this is a response to a request

eventType—Contains the reason for the callback event

deviceldentifier—Pointer to a string that uniquely identifies the device related to this event, if this is a system event, this will be NULL.

The PIACallbackPkt structure may contain additional members (but will at least contain the above base packet structure) based upon the type of callback being performed. If additional members are required, they will immediately follow the base packet structure in memory. This is described in the specific system event definition or event handler definition (since the return data would be specific to the event handler that was invoked) in the case of asynchronous IOCTL events.

As noted above, the second method used by the Central Agent to notify its clients is to signal a client-owned event object. The client creates this object and registers it with the Central Agent. When the client is signaled, the client should respond by calling the IOCTL PIA_IOCTL_GET_EVENT_RESULTS. This approach is used primarily by clients running in a different process space, since a direct callback is not possible.

With either type of notification, it is up to the client to determine the type of notification (from the eventType) that is occurring and carry out any needed processing or ignore the notification. A number of system event notifications can be utilized, of which the following is an example:

2.3.1 POST_BOOT_EVENT

The Central Agent broadcasts this system event to registered clients once the OS (operating system) has booted and the browser initially invoked. This is useful to clients that are waiting to generate an event request that requires the boot cycle to complete, or the browser to be running. For example, bus enumerators that have detected devices at boot time (that do not have supporting drivers present), may need to monitor for this event (since the full TCP/IP stack may not be running at the bus enumerator's init time). This would allow the OS to complete its boot, and then enable the bus enumerator to try once again to contact the agent and configure the device.

PIACallbackPkt specifics—

eventType—PIA_POST_BOOT_EVENT

3 XML Master Database

In the examples described in this document, the XML Master Database is used to define the devices and events supported by the PIA architecture. These devices and events are defined in the PIADevice.xml file. The XML describes the hierarchy of the objects and provides an extensible framework by adding new objects to the XML, including event handlers to carry out the specific event functionality. The Central Agent is the sole consumer of the XML Master Database. The Central Agent reads and parses the database to generate the device and event object trees to which it refers when processing device events generated by its clients. Using these objects, it generates a mapping between a specific device/event object and an event object, to invoke the appropriate event handler in response to a client's device event generation.

The event object tree is intended to be general, in that it only specifies what events a handler will support, without specifying any context data required by the handler. The device/event object tree is intended to represent a specific instantiation of an event handler, including the context data appropriate for that device/event combination.

Although XML is widely used and understood, a brief discussion of XML data representation will be useful to facilitate proper structuring of the database with the information specific to a given platform and set of devices. In particular, XML consists of two types of information, markup and character data. The markup describes the structure of the data. The character data is the actual data contained in the markup structure. Elements, which are used to define the structure, are specified with opening and closing angle brackets and have start and end tags similar to HTML. For example: <EVENT>is the start of an EVENT element and </EVENT>specifies the end of the EVENT element. Character data can be contained within that element. Elements can also contain other elements and their character data. The term “object” is used to encapsulate an element and any elements that it contains (for example: the <EVENT>object contains several <EVENT_PROC>objects). Using this approach, a hierarchy of objects is easily created to represent the devices, events and responses used by the PIA architecture described and illustrated in this document. Thus, the following is a sample of the PIADevice.xml.

<PIA_DEVICE_DATABASE>

<EVENT>

<EVENT_PROC>

<EVENT_CLASS>NAVIGATE</EVENT_CLASS>
<CLSID>XXX-XX-XXX-XXX</CLSID>

</EVENT_PROC>
<EVENT_PROC>

<EVENT_CLASS>EXECUTE</EVENT_CLASS>
<CLSID>XXX-XX-XXX-XXX</CLSID>

</EVENT_PROC>
<EVENT_PROC>

<EVENT_CLASS

ASYNC=“true”>EXECUTE_WAIT</EVENT_CLASS>

<CLSID>XXX-XX-XXX-XXX</CLSID>

</EVENT_PROC>
<EVENT_PROC>

<EVENT_CLASS ASYNC=“true”>UPDATES</EVENT_CLASS>
<CLSID>XXX-XX-XXX-XXX</CLSID>

</EVENT_PROC>
<EVENT_PROC>

<EVENT_CLASS>LOGGING</EVENT_CLASS>
<CLSID>XXX-XX-XXX-XXX</CLSID>

</EVENT_PROC>
<EVENT_PROC>

<EVENT_CLASS>SERVER</EVENT_CLASS>
<CLSID>XXX-XX-XXX-XXX</CLSID>

</EVENT_PROC>

</ EVENT>
<DEVICE>

<DEVICE_INFO>

<ID>USB\1114_20481_256</ID>
<PIA_EVENT>

<EVENT_TYPE>INSTALL</EVENT_TYPE>
<EVENT_CLASS>UPDATES</EVENT_CLASS>
<EVENT_DATA>

<ARG1>RIO 600 MP3</ARG1>

</EVENT_DATA>

</PIA_EVENT>
<PIA_EVENT>

<EVENT_TYPE>REMOVE</EVENT_TYPE>
<EVENT_CLASS>UPDATES</EVENT_CLASS>
<EVENT_DATA>
<ARG1>RIO 600 MP3</ARG1>

</EVENT_DATA>

</ PIA_EVENT>
<PIA_EVENT>

<EVENT_TYPE>ENUMERATE</EVENT_TYPE>
<EVENT_CLASS>NAVIGATE</EVENT_CLASS>
<EVENT_DATA>

<ARG1>http://TVTest0//interact//getuser.asp?deviceID=

</ARG1>

<ARG1 SUBSTITUTE=“true”>DEVICEID</ARG1>
<ARG1>&SiliconNum=<ARG1>
<ARG1 SUBSTITUTE=“true”>SILICONID</ARG1>

</EVENT_DATA>

</ PIA_EVENT>

</ DEVICE _INFO>
<DEVICE_INFO>

<ID>printer device ID string</ID>
<PIA_EVENT>

<EVENT_TYPE>INSTALL</EVENT_TYPE>
<EVENT_CLASS>UPDATES</EVENT_CLASS>
<EVENT_DATA>

<ARG1> HP LaserJet </ARG1>

</EVENT_DATA>

</ PIA_EVENT>
<PIA_EVENT>

<EVENT_TYPE>REMOVE</EVENT_TYPE>
<EVENT_CLASS>UPDATES</EVENT_CLASS>
<EVENT_DATA>

<ARG1> HP LaserJet </ARG1>

</EVENT_DATA>

</ PIA_EVENT>
<PIA_EVENT>

<EVENT_TYPE>ENUMERATE</EVENT_TYPE>
<EVENT_CLASS>NAVIGATE</EVENT_CLASS>
<EVENT_DATA>

<ARG 1>http://TVTest0//printeract//inksupply.html</AR

G1>
</EVENT_DATA>

</ PIA_EVENT>
<PIA_EVENT>

<EVENT_TYPE>DIAGNOSTIC</EVENT_TYPE>
<EVENT_CLASS>EXECUTE</EVENT_CLASS>
<EVENT_DATA>

<ARG1>file://System//HPDiag.exe</ARG1>
<ARG2>/v /s </ARG2>

</EVENT_DATA>

</ PIA_EVENT>

</ DEVICE_INFO>
<DEVICE_INFO>

<ID>USB\PRINTERS</ID>
<PIA_EVENT>

<EVENT_TYPE>NO_SUPPORT</EVENT_TYPE>
<EVENT_CLASS>NAVIGATE</EVENT_CLASS>
<EVENT_DATA>

<ARG1>file://content//printers.html</ARG1>

</EVENT_DATA>

</ PIA_EVENT>

</ DEVICE_INFO>
<DEVICE_INFO>

<ID>GENERIC_UPDATE</ID>
<PIA_EVENT>

<EVENT_TYPE>INSTALL</EVENT_TYPE>
<EVENT_CLASS>UPDATES</EVENT_CLASS>
<EVENT_DATA>

<ARG1></ARG1>

</EVENT_DATA>

</ PIA_EVENT>

</ DEVICE_INFO>

</DEVICE>

</PIA_DEVICE_DATABASE>

The above sample illustrates 6 classes of event handlers and 4 devices referencing a total of 3 different classes of event handlers. Given this background, the following discussion focuses on the descriptions of the individual objects and elements within the XML database, and how they relate to the object hierarchy. Reference should be made to the above sample while reviewing the following object descriptions.

3.1 EVENT

The EVENT sub-tree defines the possible events supported by PIA and the external event components that carry out the event handling. A single EVENT element is required to encapsulate all the events within it.

3.1.1 EVENT_PROC

The EVENT_PROC element is used to define a single class of event. At least one EVENT_PROC element is required in the EVENT element.

A single EVENT CLASS is required in an EVENT_PROC whose data is used as an identifier for this event. The EVENT_CLASS element may also contain the ASYNC attribute. The attribute is optional, with only the values ‘true’ and ‘false’ accepted. By default, ‘false’ is assumed, so one need only specify the attribute if setting it to ‘true”. In the examples described in this document, setting ASYNC to ‘true’ causes the Central Agent to spawn a separate thread to execute the handler, since the operation is a lengthy one.

A single CLSID element is required in an EVENT_PROC whose data identifies the actual COM component that carries out the event handling. The Central Agent uses the CLSID to invoke the COM object. This object must implement the IPIADevEvent interface. Further detail is provided in the PIA Device Event Handlers section of this description.

3.2 DEVICE

The DEVICE sub-tree defines the possible devices supported by PIA and the events supported for each device. A single DEVICE element is required to encapsulate all the devices (and their events) within it.

3.2.1 DEVICE_INFO

The DEVICE_INFO element is used to define a single device. At least one DEVICE_INFO element is required in the DEVICE element.

A single ID element is required in a DEVICE_INFO whose data is used as a unique identifier for this device. In some instances, this might be a “plug n play” device ID. In the case of USB, this is defined as ‘USB\’ followed by the data used to locate the driver in the registry (trailing ‘Default's are unnecessary). Additional detail regarding USB device IDs is set forth in the previously-referenced Microsoft Windows CE documentation section regarding USB registry usage and the LoadClients sub-tree.) This ID is passed (by the client) into the deviceIndentifier member of the IOCTL packet for those IOCTLs that are device specific.

At least one PIA_EVENT element is required in a DEVICE_INFO element and encapsulates a single event (and associated data) supported for this device.

A single EVENT_TYPE is required in a PIA_EVENT whose data is the name of this event. This EVENT_TYPE string is passed into the eventType member of the IOCTL packet for the PIA_IOCTL_DEVICE_EVENT and PIA_IOCTL_QUERY_DEVICE_EVENT IOCTLs.

A single EVENT_CLASS is required in a PIA_EVENT whose data creates a mapping between this event and an event handler specified in the EVENT sub-tree (also specified as EVENT_CLASS).

An optional EVENT_DATA element may exist in a PIA_EVENT to encapsulate the data associated with the device event. The EVENT_DATA allows for the definition of static and dynamic data that is passed to the event handlers. There is no maximum to the number of data arguments that the Central Agent will pass to the event handlers. However, each handler specifies the number of arguments that it uses.

At least one ARGx element is required in an EVENT_DATA element to contain the data passed to the event handler. These arguments are specified as ARGx, starting with ARG1 as the first argument, up to ARGn, where ‘n’ is the total arguments supported by a given event handler. Also, it may be necessary to break any argument into sub strings, to specify inline parameter substitution. This is specified in an argument by adding the SUBSTITUTE attribute. The attribute is optional, with only the values ‘true’ and ‘false’ accepted. By default, ‘false’ is assumed, so one need only specify the attribute if setting it to ‘true’. Setting SUBSTITUTE to ‘true’ informs the Agent to perform parameter substitution on the data at the point where SUBSTITUTE is specified.

As noted above, devices specified in the XML can be either general, or very specific. The preceding example illustrates a general device case. The DEVICE_INFO ID that is specified as USB\Printers specifies a generic printer class. In addition, however, the PIA_EVENT specified as NO_SUPPORT illustrates how a USB bus enumerator could generate an event when a new printer is encountered that cannot be supported at all. In this example, a navigation occurs to a web page that specifies he brand of printers supported on the STB. This is a significant advantage of the invention, in that the PIA system can provide support for previously un-encountered peripheral devices/events.

3.3 Parameter Substitution

The Central Agent will perform parameter substitution on the argument data (ARGx) within the DEVICE database if specified through the SUBSTITUTE attribute. The Central Agent checks the content data within the ARGx to verify whether it is a parameter for which it can substitute appropriate data. If the parameter is a supported one, the Agent will perform the substitution at the time of generating the call to the event handler, and substitute the run time data in its place within the arguments, as described below in connection with PIAProcessEvent.

The XML example set forth above contains one case in which ARG1 is specified multiple times for this purpose. When this occurs, the ARG1 content is concatenated together in the order that it appears in the XML tree, to form the complete ARG1 data string passed to the event handler. During this process, when the SUBSTITUTE attribute is encountered, the parameter to be substituted (DEVICEID and SILICONID in this example) is replaced in line with the run time data associated with this parameter.

By way of example, SILICONID is the unique machine identifier retrieved from GetUniqueMachineID. There are many uses for passing the silicon ID in a URL. This ID can be used by the server to manage conditional access, or interact with a back end billing agent for a specific STB.

4 PIA Device Event Handlers

In the examples described herein, the device event handlers are instantiated by the Central Agent when a client generates a specific device event. The device event handlers have the following responsibilities:

Follow a specific format that all event handler modules must support to accomplish the goal of extensible handlers; and

Carry out the event processing needed to satisfy the request.

Device Event handlers are in proc COM objects, each developed to accomplish a specific device event action. The handlers are instantiated through the CLSID specified in the XML database. These objects are not intended to be scriptable; thus permitting them to be compact and efficient. Each handler supports the IPIADevEvent interface to provide a generic interface to all handlers.

An event handler whose event processing can be lengthy should specify the ASYNC attribute in its EVENT_CLASS in the EVENT database. The event handler does not need to spawn a separate thread to perform lengthy operations, but can perform its functions synchronously. It is the responsibility of the Central Agent to spawn a separate thread for asynchronous operations and handle the notification issues upon completion.

The following discussion illustrates the interface used by the Central Agent to communicate with the device event handlers, and provides further examples of device handlers and their representations in the database.

4.1 IPIADevEvent

The Central Agent uses this interface to communicate with the event handlers. This interface contains the methods next described.

4.1.1 PlAlnitEventHandler

The event handler performs any of its internal initialization at this time.

HRESULT PIAInitEventHandler( );

Return Values

This method returns S_OK for success and S_FALSE on failure.

Remarks

When the Central Agent instantiates the event handler, this method will be called to allow the handler to perform any needed operations prior to the specific event request.

4.1.2 PIAProcessEvent

This method is called by the Central Agent to carry out event processing (in response to a client calling the PIA_IOCTL_DEVICE_EVENT IOCTL).

HRESULT PIAProcessEvent([in] LPVOID * argDataPacket, [in] LPVOID eventData, [in] DWORD eventDataSize, [in] TCHAR * eventClass, [in] TCHAR * eventType, [in] TCHAR * deviceldentifier, [in, out] LPVOID * outputBuff);

argDataPacket—Pointer to a packet that specifies the argument data. The argument data is retrieved from the XML database for the device/event. This parameter may be NULL if no arguments are specified in the XML. Since argument usage varies per event handler, this packet is further defined in each of the event handlers. The structure of the packet is:

argDataPacket

| | |
|---|---|
| DWORD | argCount |
| TCHAR* | argPointer1 |
| TCHAR* | argPointerN |

argcount—Count of argument pointers that follow in this packet.

argPointerl—This is the first in an array of argument pointers. Each argument pointer points to a string of data specified in the XML file. If the event handler specifies an optional argument that is not meaningful to a specific device/event combination, the placeholder for the argument should remain in the packet and be set to NULL (and the argument should exist in the XML as an empty element). For example, if 4 arguments are specified for a handler, but argument 3 is not used in a specific case, the 4 arguments should exist in the packet with the third argument equal to NULL, and argCount will equal 4.

eventData—Pointer to data that accompanies the device event IOCTL (this data is passed in the eventData member of the PIADeviceEvent packet). Since eventData usage varies per event handler, this is further defined in each of the event handlers.

eventDataSize—Size of eventData or 0 if eventData not supported

eventClass—Pointer to the eventClass of this eventType as defined in the database. This allows a single event handler to handle multiple events through the same interface.

eventType—Pointer to the eventType that accompanies the device event IOCTL (this data is passed in the eventType member of the PIADeviceEvent packet).

deviceldentifier—Pointer to the deviceldentifier that accompanies the device event IOCTL (this data is passed in the deviceldentifier member of the PIADeviceEvent packet).

Return Values

This method returns S_OK for success and S_FALSE on failure.

Remarks

If this a lengthy request (as determined by the ASYNC attribute set to ‘true’ in the EVENT_CLASS defined in the XML file for this device event handler), the Central Agent will spawn a separate thread to handle this request. The event handler will not return from this call until the request has been carried out or failed.

4.2 Standard Event Handlers

In the embodiments described in this document, the PIA system contains frequently-used event handlers that implement device event functionality, each defined as an EVENT_PROC in the EVENT database. These built-in handlers are implemented as COM objects and support the IPIADevEvent interface. Since the list of event handlers is extensible, custom event handlers may also be developed and added to the database for inclusion in an OEM's implementation of the PIA system.

When the Central Agent receives a device event from a client (through the PIA_IOCTL_DEVICE_EVENT), the Central Agent confirms that the device/event combination exists in the DEVICE database and then maps the specified event to an event handler in the EVENT database. The Central Agent then retrieves the event data from the device/event in the database and invokes the appropriate event handler with the specified data. The following are examples of event handlers:

4.2.1 UPDATES

This event handler is specified in the EVENT database as the UPDATES EVENT_CLASS. This EVENT_CLASS should have the ASYNC attribute set to ‘true’. This event class supports two EVENT_TYPEs in the device database, the INSTALL and REMOVE event types. A PIA client calls the PIA_IOCTL_DEVICE_EVENT with the eventType (in the PIADeviceEvent packet) set to INSTALL or REMOVE to perform a software update.

This event handler communicates with the Client Configuration Agent (CCA) on the STB to request (INSTALL) or remove (REMOVE) a subscription for the specified device. CCA in turn will contact CCS to request/remove the subscription support for this device. If the request is for an INSTALL, CCA will receive an archive from CCS and then perform the installation of packages received. In the case of removal, CCA will receive the approval to remove the subscription and perform the removal process of the associated packages.

The PIAProcessEvent method arguments have the following definition for this call:

argDataPacket contains—

argCount—1

argPointer1—Pointer to ARG1 data in the device/event database—this data is the channel alias used to pass to CCA. The channel alias is the subscription for the device being added or removed.

eventData—Used only if the caller specifies the channel alias directly, otherwise this should be NULL

eventDataSize—Size of the eventData string if specified or 0 if not.

eventClass—UPDATES

eventType—INSTALL or REMOVE

deviceldentifier—ignored

Return Values

This method returns S_OK for successful installation or removal of the specified channel or S_FALSE on failure. GetLastError can be called on failure to retrieve the CCA failure code.

4.2.2 NAVIGATE

The NAVIGATE event handler is not implemented as a separate handler, but is described here as an example of the functionality and definition of the argument data. This event handler is specified in the EVENT database as the NAVIGATE EVENT_CLASS. This event class does not alter its processing based upon the eventType. In this case, the EVENT_TYPE in the device/event database is used to distinguish between different URLs to navigate to for different circumstances. This event handler will communicate with the UI Control to request browser navigation to the specified URL. The UI Control will be signaled through its event notification object. Execution will then return back to the Central Agent (and its client). The PIAProcessEvent method arguments have the following definition for this call:

argDataPacket contains—

argCount—1

argPointer1—Pointer to ARG1 data in the device/event database—this data contains the full URL that the browser will navigate to.

eventData—Ignored

eventDataSize—Ignored

eventClass—NAVIGATE

eventType—eventType as described above

deviceldentifier—Ignored

Return Values

This method returns S_OK if the UI Control is signaled S_FALSE if not.

4.2.3 EXECUTE

This event handler will run a program on behalf of the caller. This event handler is specified in the EVENT database as the EXECUTE EVENT_CLASS. This event class does not alter its processing based upon the eventType. In this case, the EVENT_TYPE in the device/event database is used to distinguish between different programs to execute based up the circumstances. The PIAProcessEvent method arguments are defined as follows for this call:

argDataPacket contains—

argcount—2

argPointer1—Pointer to ARG1 data in the device/event database; this data specifies the program to execute. This may be either a fully qualified path/program name or simply the program name that is used to invoke CreateProcess.

argPointer2—Pointer to ARG2 data in the device/event database; this data is the command line arguments passed to CreateProcess.

eventData—If specified, this is an override to the command line arguments passed to CreateProcess. If this is non-NULL, this will be substituted for arg2Pointer data.

eventDataSize—Size of the eventData string if specified or 0 if not.

eventClass—EXECUTE

eventType—eventType as described above

deviceldentifier—ignored

Return Values

This method returns S_OK if the CreateProcess succeeded S_FALSE if not.

4.24 EXECUTE_WAIT

This event handler will run a program on behalf of the caller. This event handler is specified in the EVENT database as the EXECUTE_WAIT EVENT_CLASS. This event class does not alter its processing based upon the eventType. In this case, the EVENT_TYPE in the device/event database is used to distinguish between different programs to execute based up the circumstances.

This EVENT_CLASS should have the ASYNC attribute set to ‘true’. The event handler monitors the application until it terminates.

The PIAProcessEvent method arguments have the following definition for this call:

argDataPacket contains—

argCount—2

argPointer1—Pointer to ARGO data in the device/event database; this data specifies the program to execute. This may be either a fully qualified path/program name or simply the program name that is used to invoke CreateProcess.

argPointer2—Pointer to ARG2 data in the device/event database; this data is the command line arguments passed to CreateProcess.

eventData—If specified, this is an override to the command line arguments passed to CreateProcess. If this is non-NULL, this will be substituted for arg2Pointer data.

eventDataSize—Size of the eventData string if specified or 0 if not.

eventClass—EXECUTE WAIT

eventType—eventType as described above

deviceldentifier—ignored

Return Values

This method returns S_OK if CreateProcess was successful S_FALSE on failure.

5 PIA Bus Enumerators

In the examples described in this document, the bus enumerators have the following responsibilities:

To determine if the appropriate software is installed on the client to support a given device;

To generate an ‘INSTALL’ device event to request software to support a new device;

To generate a ‘REMOVE’ device event when devices are removed to potentially support temporary device installations; and

To notify the Central Agent of any other events that are specific to this bus.

Bus enumerators communicate with the Central Agent via an IOCTL interface. Further detail is provided above in the Central Agent IOCTL Interface section. Bus enumerators typically generate calls to the Central Agent to request software updates. Additionally, bus enumerators may be tasked to monitor system events. In either case, the bus enumerator will need to register a callback mechanism to be notified of these system events or when a software update has completed. In order to do this, the bus enumerator should perform a PIA_IOCTL_REGISTER EVENT NOTIFICATION call to register its callback mechanism. It will receive its notifications through the mechanism it registers, either the direct callback or the event object.

When a bus enumerator detects a new device, it will determine if the device has software already resident on the client to support the device. If the software does not exist to support the device, the bus enumerator will invoke the PIA_IOCTL_QUERY_DEVICE_EVENT IOCTL to determine if software is available to handle this device. Some bus enumerators (e.g. USBSnoop) may have several classes of devices (and device names) that describe a given device. In this case, multiple calls may be necessary to determine device support. Once the bus enumerator determines device support, the enumerator calls the PIA_IOCTL_DEVICE_EVENT IOCTL with the eventType set to ‘INSTALL’ to request the software update. The bus enumerator will wait until it receives notification back through its notification mechanism on the update before proceeding with the load of the driver or failing the device enumeration.

When a bus enumerator detects the removal of a device, the enumerator calls the PIA_IOCTL_DEVICE_EVENT IOCTL with the eventType set to ‘REMOVE’ to potentially remove the software. This will occur only if the Central Agent determines that it is a temporary device that should result in the immediate removal of its supporting software. The bus enumerator simply makes the call to enable a removal and doesn't need to perform any further processing.

Bus enumerators may also be tasked to monitor for the POST_BOOT_EVENT system event. This is important if a bus enumerator detects a new device at boot time and it needs to request a software install to support the device. As noted above, the TCP/IP stack is not fully functional until late in the boot process. If the bus enumerator executes earlier in the process (as is the case with USB) and detects the device, it will fail at requesting a software update at that time. In this case, if it monitors for the POST_BOOT_EVENT (through the registered callback mechanism), it can re-try the INSTALL request when the boot process completes.

Bus enumerators have very little PIA requirements placed on them other than the basic communication method described above. Full bus enumerators are implemented in a manner that is consistent with the driver architecture with which they are associated. The mechanism to load them and determine device support (through already installed software) is specific to each bus enumerator and is well within the skill of implementers.

The names used for deviceIdentifiers must be coordinated with the database contents that the Central Agent uses to check for software support. This will be in the form of the XML data file that exists on the client (that can be updated by the server as new software if added) but is coordinated with the server content so a mapping occurs between these deviceIdentifiers and their associated software. In reviewing the XML database, the deviceIdentifiers that are passed in the IOCTL calls to the Central Agent, should map directly to the ID element within a specific DEVICE_INFO element in the DEVICE database.

6 PIA Device Drivers

The device drivers have the following responsibilities:

To notify the Central Agent when a device has been successfully enumerated; and

To notify the Central Agent of any other events that are specific to this device.

Device drivers communicate with the Central Agent via an IOCTL interface, as described in the Central Agent IOCTL Interface section. Once a device has been successfully enumerated (configured by the driver) the device driver will call PIA_IOCTL_DEVICE_EVENT (generally with an eventType of “ENUMERATE”) to notify the agent that a new device is present in the system.

A device driver may need to generate other events specific to the device it supports. The is especially useful if the device may require user interaction while its running. “Printer Low Ink” or “Out of Paper” are common examples, which require the user to be alerted to the problem. Another application is to alert the user to perform some maintenance on a device, which in the PIA system, could result in the user being instructed on how to perform the maintenance. In each instance, the device driver needs to generate the specific event to the Central Agent; and the XML database must contain the DEVICE_INFO to specify this device, along with the PIA_EVENTS (and associated elements) that the device driver will be generating. If the processing required to handle the event is available through a standard event handler, only the device-specific data need be specified to carry out the functionality. In some cases, a device may require some special processing in response to a device event (e.g. run this diagnostic). In this case, a device specific event handler should be developed, added to the EVENT database and referenced in the device specific DEVICE_INFO elements.

If a device driver is tasked with monitoring system events, or will be generating asynchronous events and wants to be notified of the results, it must register a callback mechanism. To do this, the device driver should perform a PIA_IOCTL_REGISTER_EVENT_NOTIFICATION call to register its callback mechanism.

Device drivers have very little PIA requirements placed on them other than the basic communication method described above. Device drivers are implemented in a manner that is consistent within the driver architecture that they are associated with.

7 PIA UI Control

In the examples described in this document, the UI Control is an ActiveX control instantiated through HTML and the Browser. This occurs in an HTML page called PIALoad.html. TVFullScreenBoot.html creates a layer called “PIA_layer” and opens PIALoad.html in it. This page need not have any UI components, but simply is responsible for instantiating the UI Control and fielding the events fired from the control. The UI Control has the following responsibilities:

Notify the Central Agent upon initialization;

Notify the Browser to navigate to a new URL;

Notify the Central Agent when a new channel subscription is desired from PIA;

Notify the Browser when the update process has completed or failed; and

Manage the UI navigation requests as changes occur.

The UI Control provides a dispinterface to allow it to be controlled from Javascript. The UI Control is instantiated through the PIAUIControl object and the IPIAUIControl interface is used by Javascript to communicate with it. The IPIAUIControlEvents event interface is used by the UI Control to communicate events into the Browser. The PIAUIControl object is a Singleton object, and thus multiple pages instantiating this object will result in a single object accessible by all who reference it.

7.1 IPIAUIControl Interface

The PIA UI Control has the ability to request the addition or removal of subscriptions from the Central Agent just as a driver would. Also, the PIA UI Control has the ability to override the navigation requests that are generated due to device events. The IPIAUIControl interface is called by Javascript carry out these functions. The IPIAUIControl interface contains the following methods:

7.1.1 PIAInit

This method enables the UI Control to perform its initialization.

HRESULT PIAInit( );

Return Values

This method returns S_OK for success and S_FALSE on failure.

Remarks

This call is performed once upon initialization of the Browser. The PIALoad.html page performs this call.

7.1.2 PIARequestSubscription

This method is called to request a subscription to a channel from an HTML page.

HRESULT PIARequestSubscription([in] BSTR channelAlias);

channelAlias—String that identifies the channel that is associated with the request.

Return Values

This method returns S_OK for success and S_FALSE on failure.

Remarks

The UI Control will communicate this request to the Central Agent (by calling the PIA_IOCTL_DEVICE_EVENT for eventType INSTALL). It is expected that the channelAlias is known since the HTML page is probably delivered from the server. This method will return immediately and the results posted to the appropriate IPIAUlControlEvents handler.

7.1.3 PIARemoveSubscription

This method is called to request the removal of a channel subscription from an HTML page.

HRESULT PIARemoveSubscription([in] BSTR channelAlias);

channelAlias—String that identifies the channel that is associated with the request.

Return Values

This method returns S_OK for success and S_FALSE on failure.

Remarks

The UI Control will communicate this request to the Central Agent (by calling the PIA_IOCTL_DEVICE_EVENT for eventType REMOVE). It is expected that the channelAlias is known since the HTML page is probably delivered from the server. This method will return immediately and the results posted to the appropriate IPIAUlControlEvents handler.

7.1.4 PIAUpdateURL

This method is called to change the normal navigation behavior for a given device from an HTML page.

HRESULT PIAUpdateURL([in] BSTR eventType, [in] BSTR deviceID, [in] BSTR urldata, [in] BOOL enableNavigation);

eventType—String that identifies the eventType to change the navigation behavior of. If the eventType=“GLOBAL”, all events will navigate to this URL if enableNavigation is true. If the eventType=“GLOBAL”, and enableNavigation is false, all navigation for this device will be disabled.

deviceID—Device ID used to uniquely identify this device in the registry under the PIADevices sub-tree

urlData—New URL to navigate to when this event occurs

enableNavigation—True enables navigation to this URL for this event, false disables navigation for this event for any URL.

Return Values

This method returns S_OK for success and S_FALSE on failure.

Remarks

The UI Control will add or update the registry entries in the PIADevices sub-tree for this device. Additional detail regarding registry entries affected by this call is set forth in the PIA UI Control section.

7.2 IPIAUIControlEvents Interface

The UI Control communicates to Javascript through these events. This interface contains the following methods that are implemented in the Javascript:

7.2.1 OnNavigate

This event instructs the browser to navigate to a URL.

HRESULT OnNavigate([in] BSTR newURL);

newURL—new URL to navigate to when this event occurs

Return Values

This method returns S_OK for success and S_FALSE on failure.

Remarks

This event is fired whenever the UI Control has received a request from the Central Agent to navigate to a specific URL. The UI Control looks up the device in the PIADevices sub-tree in the registry to determine whether navigation is enabled for this device/event and also to determine if the URL has changed from the instructions in the master database. The UI Control will only fire this event if it has determined that navigation is enabled for this device/event (or not overridden).

7.2.2 OnSubscribeOK

This event informs the browser that its request to subscribe to a new channel has completed successfully.

HRESULT OnSubscribeOK([in] BSTR channelAlias);

channeiAlias—String that identifies the channel that is associated with the request.

Return Values

This method returns S_OK for success and S_FALSE on failure.

Remarks

This event is fired when a channel subscription has been completed successfully and the software is installed.

7.2.3 OnSubscribeFail

This event informs the browser that its request to subscribe to a new channel has failed.

HRESULT OnSubscribeFail([in] BSTR channelAlias);

channelAlias—String that identifies the channel that is associated with the request.

Return Values

This method returns S_OK for success and S_FALSE on failure.

Remarks

This event is fired when a request to subscribe to a channel has failed. The Javascript may then choose to subscribe to a different channel.

8 PIA Agent and Control Communication

In the illustrated examples, the communication between the Central Agent and the UI Control makes use of synchronization objects. Events are used to signal communication between the two components. Additionally, the UI Control may call the IOCTL interface in the Central Agent.

8.1 Event Object Communication

The following named events are defined:

8.1.1 “PIA UI Connect”

Created by the Central Agent; this event notifies the Agent that the control is running.

8.1.2 “PIA UI Event”

Created by the UI Control; this event notifies the Control when data is available.

8.2 Initialization

Upon Initialization, the Central Agent creates the “PIA UI Connect” event in the non-signaled state. When the UI Control initializes, it creates the “PIA UI Event” event in the non-signaled state. After creating this event, the UI control then signals the “PIA UI Connect” event notifying the Central Agent of its existence. This is primarily used to inform the Agent that the boot process has completed. Once the UI Control has signaled the Central Agent, the Agent is ready to receive subscription requests from the Control and the Control is ready to receive navigation directions from the Agent.

8.3 Navigation Request

When a navigation event request occurs (i.e., when a client calls the PIA_IOCTL_DEVICE_EVENT IOCTL for an eventType that has a NAVIGATION EVENT_CLASS defined in the XML file), the PIACallbackPkt is constructed by the Central Agent with data to pass the information to the UI Control regarding the navigation request. The “PIA UI Event” event is signaled by the Central Agent. The UI Control then follows up by calling the PIA_IOCTL_GET_EVENT_RESULTS to retrieve the information regarding the event. These packets are queued in the agent until they are retrieved by the UI Control. The format of the PIACallbackPkt is expanded to include:

TCHAR url

url—The URL to specify to the browser for navigation

The UI Control reads the registry entry for the device, and, based upon the eventType, determines whether the navigation URL is overridden by a URL of this type in the registry. The UI Control then orders the Browser to navigate to the specified or overridden URL.

8.4 Subscription Request

The UI Control can register an event mechanism as any other client would. When the UI Control receives a request from the Browser to subscribe/unsubscribe to a channel, the UI Control calls the PIA_IOCTL_DEVICE_EVENT IOCTL setting the eventType to INSTALL or REMOVE. It sets the deviceldentifier to GENERIC_UPDATE and passes the channel alias data in the eventData parameter. When the update is complete, the Central Agent signals the registered event object to notify the UI Control that the request is complete. The UI Control then calls the PIA_IOCTL_GET_EVENT_RESULTS IOCTL to retrieve the response.

9 PIA Registry Usage

The registry key under which the InterAct data is organized is:

HKEY_LOCAL_MACHINE\Software\Rachis\InterAct

The following describes examples of registry entries used by each component of PIA.

9.1 PIA Central Agent

The Central Agent makes use of the following data values under the InterAct key:

DataBasePath—A string value that is the path to the piadevice.xml master database. This is a required value.

CAFlags—A DWORD bit mask that allows configuration of options for the central agent. The following bit definitions exist:

Bit 0—CACleanup—enable/disable Central Agent driver cleanup

0=Central Agent does not perform any cleanup

1=Central Agent performs cleanup at the time specified in PeriodicCleanup

PeriodicCleanup—A DWORD that specifies the frequency (in seconds) that the Central Agent attempts cleanup of packages that are expired (their period of inactivity has been reached).

AutoRemove—A DWORD that specifies the duration of inactivity (in seconds) required before the Central Agent will remove PIA installed drivers. If this is set to 0, the Central Agent will remove the driver when the device is removed, or the next time it performs a clean up if the device is not present. This value may be overridden by a device specific value under the PIADevices sub-tree.

The above required registry entries are utilized by the Central Agent and PIA for the functions described herein. The optional values can also be specified to configure the Central Agent as desired.

The Central Agent creates a subkey to organize its devices under. It maintains registry entries for any device in its database that it receives an event request for. If the entries don't exist, the agent will add them when it receives a PIA_IOCTL_DEVICE_EVENT event.

PIADevices—The subkey under which the Central Agent organizes its devices.

PIADevices\Device ID—Contains the data for this device where “Device ID” is the identifier passed to the PIA_IOCTL_DEVICE_EVENT event.

The following data values are found under each PLADevices\Device ID key and are created/updated by the Central Agent:

LastAccessed—The time/date that this component was last used. This is updated by the central agent when an ENUMERATE or REMOVE event is received from a client. This is updated even if Central Agent cleanup is disabled, to allow an external component to perform some intelligent cleanup.

DeviceFlags—A DWORD bit mask that specifies options regarding this device. The following bit definitions exist:

Bit 0—PersistConfig—specifies if the driver is installed in persistent storage, this

flag comes from the XML database

0=when installed, this package is installed in RAM

1=when installed, this package is installed in persistent storage

Bit 1—DeviceCleanup—specifies if this driver is available for cleanup, this flag

comes from the XML database

0=this driver should never be removed, it may support non PIA devices

1=this driver may be removed if expired

Bit 2—DriverInstall—specifies if the driver is currently installed on the client

0=the driver was installed as a temporary driver but is no longer present

1=the driver is currently installed on the client box

Bit 3—DeviceConfig—specifies if the device is currently configured

0=the device is not configured—the Central Agent clears this at boot

1=the device is configured—the Central Agent sets this at enumeration

These entries are also accessed by the Central Agent but not created by it.

AutoRemove—A DWORD that specifies the duration of inactivity (in seconds) required before this device is considered expired and available for cleanup. If this is set to 0, this device is expired upon removal, and therefore a candidate for immediate cleanup.

FriendlyName—A string that may be used by a UI display to refer to this device.

DeviceClass—The category of devices to which this device belongs.

PIADeviceData—The path to any device specific XMLdata file. This data is used to override any data for this device that exists in the master XML database.

SubscriptionAlias—The data string that identifies the package name used for removal. This is passed to the Client Configuration Agent to request the removal.

9.2 Device Drivers

Device drivers have device specific data associated with them that is maintained in the registry under the InterAct\PIADevices\Device ID key. This information should be populated as part of the installation process for each device. The following data values are found under each device specific key:

FriendlyName—A string that may be used by a UI display to refer to this device.

DeviceClass—The category of devices to which this device belongs.

PIADeviceData—The path to any device specific XMLdata file. This data is used to override any data for this device that exists in the master XML database.

SubscriptionAlias—The data string that identifies the package name used for removal. This is passed to the Client Configuration Agent to request the removal.

9.3 PIAUI Control

In the examples described in this document, the UI Control can make use of various registry entries, and the UI Control may make updates to the device-specific registry keys. The UI Control may get requests from the browser to change the navigation URL for specific event types that pertain to a device. This information can be maintained under the device-specific key as:

EventType—The event type to override navigation for (e.g. ENUMERATE). If the EventType is ‘GLOBAL’, all events will result in a navigation to this URL if GLOBAL_Flags has the appropriate bit set.

EventName—The URL to which to navigate for this event (EventName is specified in EventType).

EventName_Flags—Flags for this event type. The following bit definitions exist:

Bit 0—enable/disable navigation for the eventType

0=disable

1=enable

For example:

PIADevices\USB\1114_{—}20481_{—}256

EventType=ENUMERATE

ENUMERATE=htt://TVTest0 . . .

ENUMERATE_Flags=0×01

This example enables the navigation request of type ENUMERATE for device USB\1114_{—}20481_{—}256 to the http://TVTest0. . . url.

### Section IV. PIA Server Architecture

1 PIA Server Overview

The following discussion provides examples of the functions and architecture of the PIA Server and an application referred to herein as InterAct! The discussion utilizes, inter alia, terminology employed in publicly available documentation of Microsoft Corporation's MSTV client and server functionality:

CCS/CCA: the client configuration service (CCS) on the MSTV Server, and the corresponding agent (CCA) on the client; and

Logging facilities on the client and the server.

The PIA Server receives client messages from a number of different sources. It uses a data-driven lookup table to route the messages. A significant use of this message reader is to initiate a t-commerce (television commerce) or e-commerce transaction. The PIA Server can be implemented as an interactive application, Windows 2000 Service, a module in Microsoft SQL Server DTS (Data Transformation Services), or as a Web application. This wide range of possible implementations provides the operator with flexibility to process different kinds of t-commerce transactions in different ways.

Additional information regarding STB client and server configuration is available in the following documentation published by Microsoft Corporation of Redmond, Wash.: STB Client Configuration (“Microsoft TV Advanced 1.0 Help” Feb. 28, 2001, Rev. MSTVA-BASE-1.0C.-01-02-28-1618), and Server Client Configuration (“Microsoft TV Server 1.0 Help”, Apr. 9, 2001, Rev. MSTVS-1.0C.-01-04-09-1636), the teachings of which are incorporated in their entirety herein by reference.

In the embodiments discussed in this document, the PIA server is a suite of utility applications, which implements a “zero-click” initiator of t-commerce —i.e., a system that initiates e-commerce or t-commerce transactions automatically, without intervention by a user of a peripheral device or STB. In particular, the PIA client can generate t-commerce entries that are transmitted to the server, either through MSTV client log facilities or by other means (discussed below). The PIA server, in turn, permits the operator to specify a filter that selects log entries corresponding to t-commerce (or e-commerce) transactions. Once selected, the PIA server acts on those transactions. The corresponding actions may include, for example, completion of a commerce event, as represented by a signal into a billing database that Customer X has generated a charge of $Y.

Thus, the PIA server, as discussed in greater detail below, supports a “zero-click” functionality in which a client event, such as the push of a scanner button, can cause a transaction to be posted to a logging area (either through the PIA Action Dictionary described below, or other means). The PIA server acts as the processor of these transactions, using them to insert an event into a database (or equivalent element) that recognizes the event as a revenue event, and aggregates the charge into the account of the client who generated the event.

The following discussion also details the storage and delivery of the PIA Master Channel, which is the container for the PIA Central Agent's main dictionary. It is expected that cable operators and other providers will connect the PIA server with their existing, conventional billing programs, and thus, the workings of billing systems are not described herein.

1.1 Support Transactional Nature

As noted above, PIA provides a means for keeping the STBs in a network up to date, and also for initiating e-commerce and t-commerce. The PIA Server described in this section can identify and process any kind of transaction that an STB generates, and is not limited to PIA transactions. This flexibility is enabled by techniques described in greater detail below, for filtering input transactions and dynamically dispatching selected transactions to a database.

One component of the PIA Server is a general purpose log file filter that can be used by different applications. Log entries contain many different kinds of data, which can be used, for example, to populate a database of installations, catalog all installations, and list the hardware and software modules present in an STB. 1.2 Package Container

As noted above, the MSTV server uses a Client Configuration Server (CCS) facility to define channels that contain packages. (Packages are described in greater detail in the Microsoft Server Client Configuration documentation cited above, and incorporated herein by reference.) In the examples described herein, a package can contain any combination of OS upgrade, application code or device driver that is required in PIA, or to operate a peripheral that PIA detects. This packaging method is a standard part of the MSTV server, and the PIA server operator can manually create channels and packages using the MSTV Server facilities.

2 PIA Server Architecture

2.1 Master Channel and Download

An MSO's Set Top Box maintenance team is responsible for defining the format, contents, and usage of a “master channel archive.” The master channel archive is a package (as defined in the Package Container discussion above)that contains:

A mapping of devices that PIA supports to CCS Channel aliases (described in detail in the Microsoft Server Client Configuration documentation);

Any additional software that PIA may wish to install, including extra installation kits, such as registry settings, install scripts, backup and restore facilities. This could be extended to include PIA itself, so that it is provided as a premium (extra-cost option).

Any additional data needed to complete the installation (this may be a URL that specifies the server location of an install report.)

Any additional information, such as a URL, that the client system accesses as part of the PIA system.

The master channel format, maintenance and usage are defined in the Microsoft Server Client Configuration documentation incorporated herein by reference.

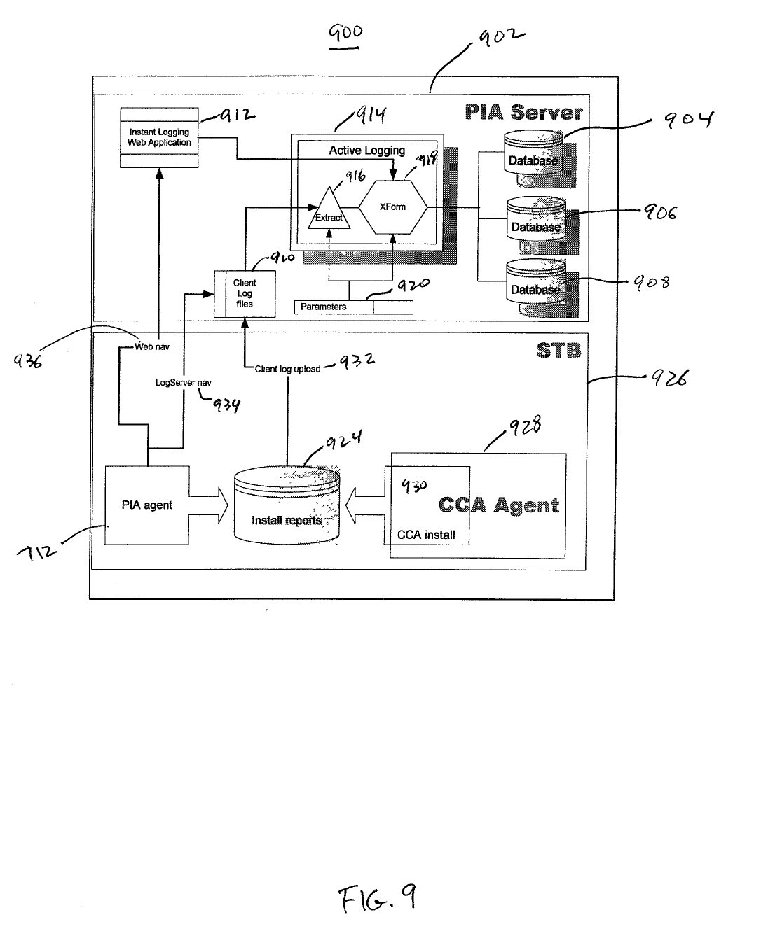

2.2 Active Logging PIA utilizes a technique known as Active Logging to capture significant events generated by the STB, and use them to populate a database. A schematic representation of the Active Logging architecture, including the PIA Server 902 and elements of STB 926, is set forth in FIG. 9. As shown therein, the Active Logging architecture includes active logging module 914 (which itself includes Extract item 916 and XForm item 918), instant logging Web application 912, client log files 910, parameters 920, and databases 904, 906 and 908. Within the STB 926, the Active Logging elements include PIA Agent 712, Install reports 924, and CCA Agent 928 (which itself includes CCA Install element 930). Each of these aspects is discussed below.

Active Logging enables a user to control all the significant aspects of data collection, including frequency, filtering and output disposition. In particular, as shown in FIG. 9, the PIA server 902 logs pre-defined transactions into one or more databases 904, 906, 908, by reading from one of several input sources. In the example shown in FIG. 9, two such sources are illustrated: a Client Log file 910, and a Web site or application 912.

3 PIA Server Functional Specification

3.1 Input Sources

3.1.1 Install reports (by MSTV client)

The CCA installation process that PIA can initiate creates reports in accord with the format described above in the PIA Client Server Architecture section of this document. This is an XML file that contains message types including WARNING, ERROR, TRACE, and DUMP. The source of these reports is the set of client machines. The reports and logs are not written directly, but passed through an API that formats the XML output, and provides it with time, date, and other relevant information. By writing an appropriate filter specification, the end-user can comb the install reports for PIA transactions or any other desired record.

3.1.2 Special Reports (by InterAct!)

Set Top Box application developers can use a standard MSTV client interface, known as CCLOG, in the PIA Agent, to create log entries dynamically. PIA can use this interface to deliver billing or other messages from the client to any receiver on the server. There can be multiple supported paths from the client to the host, which can be used independently, as will next be described.

3.1.2.1 Client Log Upload

The Set Top Box application will write a message to a log file on the PIA Client. Periodically, a ‘Client log upload’ (defined below in the Client Log Channel) service will upload these log files to a central location (shown as ‘Client Log Files’) for subsequent processing by Active Logging module.

3.1.2.2 Web navigation

The PIA Client has the capability to send log messages to a Web application, referred to as the log server, as they occur, instead of waiting for the client logs to be uploaded as described above. This log server Web application appends the message to a log file, shown as ‘Client Log Files’, for subsequent processing by the Active Logging module.

3.1.2.3 Instant Logging

The two methods noted above offer the advantages of low CPU and network usage. There will be a brief, limited transaction between the PIA Client and Server, and the rest of the back-end processing is deferred until a slack time. This may suffice for most billing or notification situations where the event can be recorded after the fact. For some situations, however, an instant message may be required. The Instant Logging technique next described meets this need.

Referring again to FIG. 9, there is shown the Instant Logging facility within the PIA architecture. Instant Logging is a component of a Web server that accepts input from a Web client. Instead of an extractor reading static disk files (as in the “Extraction” method described below), the Instant Logging facility will react to a PIA transaction as it arrives at the Web server (IIS) that is hosting Instant Logging. Thus, Instant Logging replaces the extraction step as part of the processing of a URL request from a client. In particular, the PIA Client invokes the page, and passes the arguments the page requires. The Instant Logging module responds with an “empty” page, or one that requires no action or display elements. The Web input module provides real-time signaling and billing.

Instant Logging is useful for applications that require instantaneous notification of PIA events. It requires more network and CPU resources than batch processing, but it can be offloaded from the main MSTV server onto a dedicated server.

3.2 Active Logging Server (ALS)

The Active Logging Server processes log files after the ClientLog facility has uploaded them, or it can process them as they arrive from the Instant Logging source. The ALS utilizes XML data as its input. It provides a framework to transform the files into any number of different databases, with specifiable inputs and outputs. The input can be filtered, and the output destination can be specified through the ‘Parameters' item 920 shown in FIG. 9. The Active Logging Server (ALS) module 914 can run continuously, be invoked manually, or be programmed to be run by the Microsoft Windows 2000 host batch processing facilities. Microsoft's SQL Server's DTS (Data Transformation Services) may be used to initiate the process.

The ALS 914 also is responsible for directing input records to some kind of database. It provides tools for the operator to specify which incoming reports contain data that ALS is to process; which elements of the data are to be extracted; which actions are to be performed on the output records; and how it the input is to be transformed on output.

As shown in FIG. 9, the ALS 914 consists of two main components, referred to as Extractor 916 and Transformation Module 918.

3.2.1 Extractor

The ALS Extractor 916 is responsible for locating the data files that are to be read, and extracting the desired records from them. It will leave the input data intact, and create a series of data structures in a normal form that can be imported into a billing database. The extractor will be able to accept the following parameters as input:

Input file specification, including location of the files, and a time span within those files; and

A filter specifying the kinds of records to identify and isolate.

The filter can be implemented as an eXtensible Stylesheet Language (XSL) stylesheet. XSL is a language for, among other functions, expressing stylesheets. It consists of two parts: a language for transforming XML documents, and an XML vocabulary for specifying formatting semantics. It developed from a World Wide Web Consortium (W3C) draft standard that Microsoft proposed in 1997, the teachings of which are incorporated by reference herein. Originally intended as a means to transform XML into HTML, it can also transform XML into new XML. XSL provides for powerful search facilities that allow retrieval of XML nodes that match specific data patterns.

The Extractor can be provided as a binary code module programmed by an operator who creates XSL stylesheets that define elements of interest.

3.2.2 Transformation Module

In the illustrated embodiments, the ALS Transformation Module, denominated ‘XForm’ (918) in FIG. 9, is a general-purpose transformation of its input data into a variety of output types. It can be programmed to map the input report into a number of different output formats. For example, it can use, but is not limited to, the Service Profile Object interface to access an MSTV Profile.

The ALS Transformation Module 918 should be able to detect not only certain record types, but will use a human-readable map to specify the relationship between input data and output data. For example, it should know that, in a report of class: BUYING_EVENT, that the report element SILICON_ID is the field that represents the user, and that it applies the transformation named ‘UserProfile(“get_user_from_deviceID”)’ to acquire the user object. The user and other fields can then be mapped into the Billing Database by another transform.

3.2.3 Monolithic Filter and Transformation

XSL itself provides a means to integrate both the filtering and output disposition of incoming XML. In addition, ASL will provide a means for the filter to automatically invoke the output disposition module.

4 Interaction with Other Technologies

4.1 Internet Information Server Components

In the examples described herein, the PIA Web Server consists of a Web application implemented as Active Server Pages (ASP). ASP, a widely-used technology, allows rapid development of prototype applications by executing VBScript in the context of a Web server. VBScript (Microsoft Visual Basic Scripting Edition, a subset of Microsoft's Visual Basic programming language) enables easy access to MSTV Server objects. However, the underlying system architecture permits development in other programming languages that support Microsoft COM (Component Object Model) and the like.

4.2 Service Profile Objects

SPOs are the MSTV server abstraction of database objects. They are maintained through the MSTV Server application ‘Profile Dictionary,’ an MMC (Microsoft Management Console) snap-in. The user follows certain rules that cause representations of specific SQL Server database objects in an SQL-free manner. The main benefit of SPOs is their mapping of database objects into VBScript objects for easy access.

In the examples described here, the PIA Server Web server uses SPOs through IIS as the access to the MSTV Server data base. It also contains a new SPO to write billing events into another external database.

4.3 Service Configuration Objects

An SCO is the “file system” underneath an SPO, whereby each SPO node accesses its underlying data through an SCO. In the examples described, the PIA Web Application uses the SQL Server SCO for subscriber, device and other SPOs, and can use the SQL SCO to maintain a database of synthesized device events.

4.4 ISAPI Extensions

ISAPI (Internet Server API) is a W3C standard for the manner in which an Internet Server can include binary extensions that provide application functionality. ISAPI is essentially an argument-marshalling protocol that allows IIS to pass data between itself and a Win32 DLL. The DLL, in turn, writes the HTML that the browser sees back through IIS. ISAPI extensions can provide a highly scalable and robust technology. It can be implemented in a system-level language (C++) and can provide fine control over the resources it uses, such as IIS threads.

5. PIA Server as a Configurable Intermediary

5.1 Notational Conventions

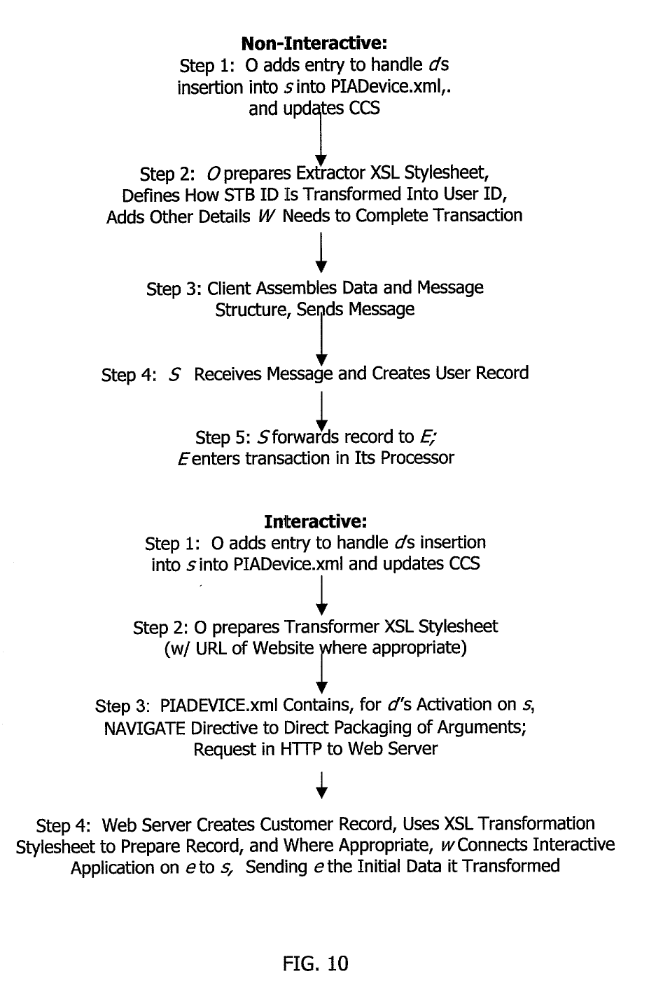

The following discussion, which refers to the flowchart of FIG. 10, describes a typical case of an Operator, ‘o’ provisioning a PIA system to react when device ‘d’ is activated on STB ‘s.’ Other entities in the system can include: the subscriber ID ‘u’ for the user who owns s; the PIA server ‘p’ who processes the PIA transaction; a possible accompanying server ‘w’; and a final e-commerce transaction server ‘e ’.

5.2 Preparation

The following is a description of the preparation of the data files that drive the PIA client and server.

5.2.1 Step 1

The operator, o adds an entry to handle d's insertion into s into PIADevice.xml. O updates the MSTV Server's CCS system to ensure that the new instructions are sent to participating STBs in the network.

5.2.2 Step 2

5.2.2.1 Non-interactive Example

In a non-interactive example, o prepares the Extractor XSL (916 of FIG. 9) stylesheet. O defines how the STB ID is transformed into a user ID, and adds any other details that the non-interactive Billing Event processor w needs to complete a billing transaction.

5.2.2.2 Interactive Example

In an interactive case (i.e., utilizing access to a URL to obtain additional software or data), o prepares the Transformer XSL (918 of FIG. 9) stylesheet discussed above. The preparation may contain the steps noted above in the non-interactive example, with the addition of the URL of a Web site that the PIA Server will connect with the STB.

5.3 Operation

The following describes the steps executed in typical operation of a PIA server.

5.3.1 Steps 3-5, Non-interactive Example

5.3.1.1 Step 3

On d activation, the PIA client assembles that data and message structure that the PIADevice.xml case for the particular device and event specifies,. It sends the message according to the format that PIADevice specifies (for example, a message type of POST, or LOG, where the message is POSTed to a server, or logged to an STB file.)

5.3.1.2 Step 4

The server s receives the message and creates a user record by applying the rules in the XSL Transformation database for mapping data sources. This step prepares everything that e requires to process the transaction.

5.3.1.3 Step 5

S disposes of the record by forwarding it to e. E enters the transaction in its own processor.

5.3.2 Steps 3-4, Interactive Example

The following steps are executed when the PIA Server initiates an interactive session between an e-commerce (or t-commerce) system and the user on an STB.

5.3.2.1 Step 3

PIADEVICE.xml contains, for d's activation on s, a NAVIGATE directive that directs the packaging of arguments (as in the non-interactive example discussed above). In this case, the request is in the standard HTTP format, to a Web server.

5.3.2.2 Step 4

The Web server creates a customer record from the data sent up in the previous step. As in the non-interactive example, the server uses the XSL Transformation Style sheet to prepare the record. W can either contain all the necessary processing itself, or can use HTTP facilities to connect an interactive application on e to s, sending to e the initial data it transformed.

6 InterAct! Server

6.1 Overview

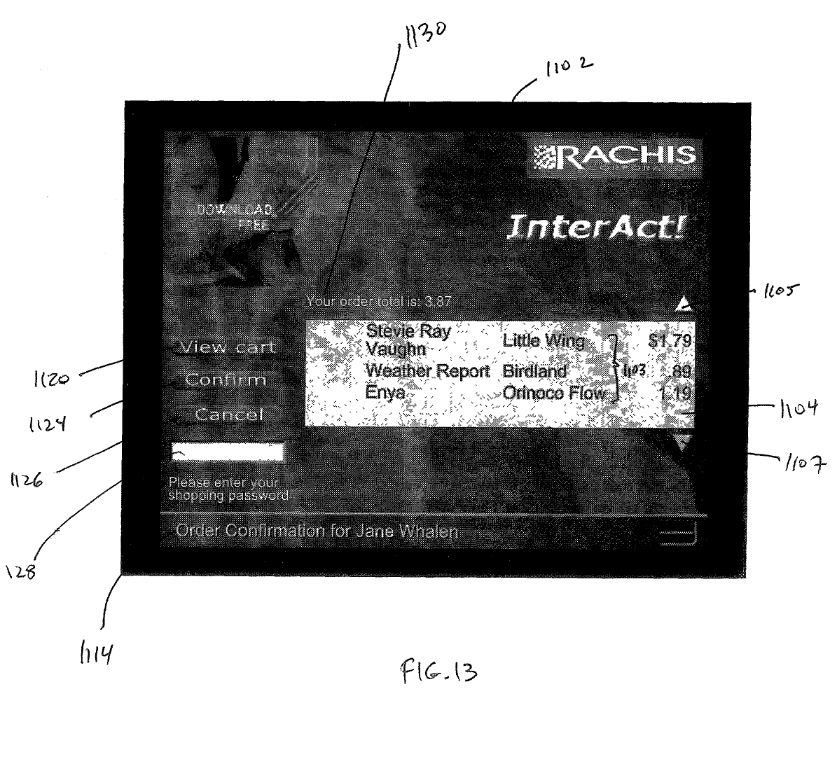

InterAct! Server is a Web application for the PIA environment that provides interactive e-commerce (and t-commerce) by enabling a user or customer to choose from a selection of categories, and then registering their purchases of items from those categories. Examples of features of the InterAct! Server functionality are depicted in FIGS. 13-18, which depict displays generated by the system.

6.2 Architecture

6.2.1 Operating Environment

In the illustrated examples, InterAct! Server is implemented as a Microsoft Active Server Pages (ASP) application. In this environment, the operator uses Microsoft Internet Information Server (IIS) controls to designate all the files in a given directory as a Web application. This allows all the Web page files in that directory to share data inside IIS. It also allows for application-wide initialization of variables shared by the pages.

InterAct! Server can be implemented in the VBScript language, and use objects provided by Microsoft TV Server (MSTV Server).

The illustrated examples of the InterAct! Server also contain a custom billing module, implemented as a Service Profile Object (SPO). As noted above, an SPO is an MSTV Server facility for creating custom back-ends to MSTV Server. The InterAct! Server uses a customized dictionary to provide the categories from which a user may choose, the data associated with each category, and the price of the items therein.

6.2.2 Application Architecture

The InterAct! Server allows the operator to specify:

The data source, or catalog, of items to be offered (please refer to §6.3.7, ‘XML File’ for the format of the catalog)

The source for images on the resulting web page.

These variant display elements are determined by the arguments sent to the Web Server when the InterAct! client requests the page. The example in §6.3 shows InterAct! invoked with a catalog of (duly licensed and authorized) songs that the user orders for download to their player.

6.3 Functional Description

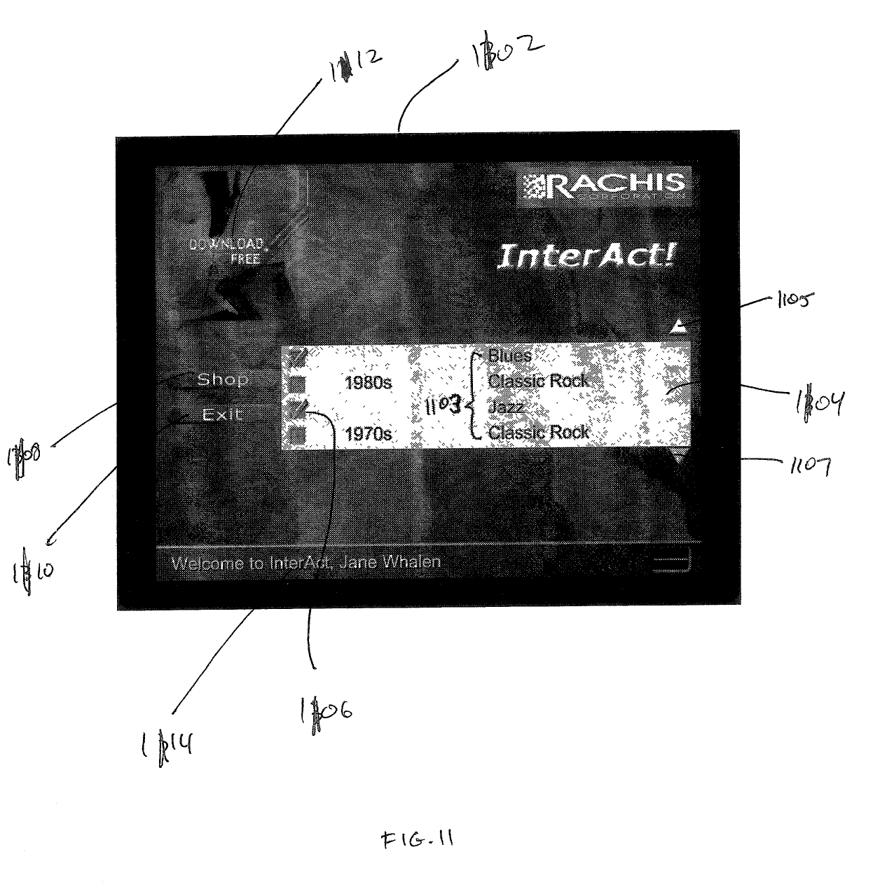

Referring now to FIGS. 11-16, the following discussion illustrates the processing of each page in the InterAct! System.

6.3.1 Processing Common to all Pages

The InterAct! server uses the VBScript language (under the ASP component of IIS) to generate the HTML that the client STB displays. The server includes in that HTML programming instructions and associated data in JavaScript, a script language the client can process.

The server extracts from a database the song catalog, and any other variant display elements (specific to the kind of device that the InterAct! server processes). It includes a transformation of that data, as well as other necessary programming directives, in the output page. Other code necessary to execute the output page properly is stored in a file that the output page includes by reference.

The purpose is to allow the client to scroll through the display of the catalog and select items from it without having to re-invoke the server for every refresh of the screen. The scrolling is invoked from control buttons that the InterAct! server includes on each page.

6.3.2 Getuser.asp

Arguments:

SiliconID: An unformatted alphanumeric string that uniquely identifies the hardware of the STB that is invoking InterAct!

Functional Description:

Getuser.asp creates the MSTV object “Client.WtvBroker” to gain access to the MSTV Server database. It queries the database for the user object corresponding to the SiliconID. It stores that user object in the application global space. It then creates an XML document with the “Microsoft.XMLDOM” object. It initializes the document from a disc file that the user configures for each application (a sample is provided in the discussion below of XML files). Referring now to FIG. 11, Getuser.asp reads and parses the “OnBoardSongs” tree in the XML document and displays the selected fields to the user. Note, in FIG. 11, the user name 1114 (“Jane Whalen”) personalizing the screen 1102. This user name is extracted from the “Client.WtvBroker” object. The user then selects and “clicks” on one or more of the categories 1103, using the checkboxes 1106 provided on the form and depicted in FIG. 11. In the example of FIG. 11, the user has selected “Blues” and “Jazz”. Pressing the ‘Shop’ button 1108 shown in FIG. 11 invokes the ‘ShowAvailable.asp’ screen. (An ‘Exit’ button 1110 is provided for terminating the session; and the user can scroll up or down through categories displayed in menu area 1104, using conventional navigation buttons 1105 and 1107.) Getuser.asp uses the ID node of the Song tree for each selected item, and concatenates the ID nodes into a list that HTTP passes to the next screen, using the HTTP POST protocol.

6.3.3 ShowAvailable.asp

Arguments:

OnBoardSongs: A list of numbers that represent the IDs of the items selected by Getuser.asp. (e.g. ‘1 5’).

Processing:

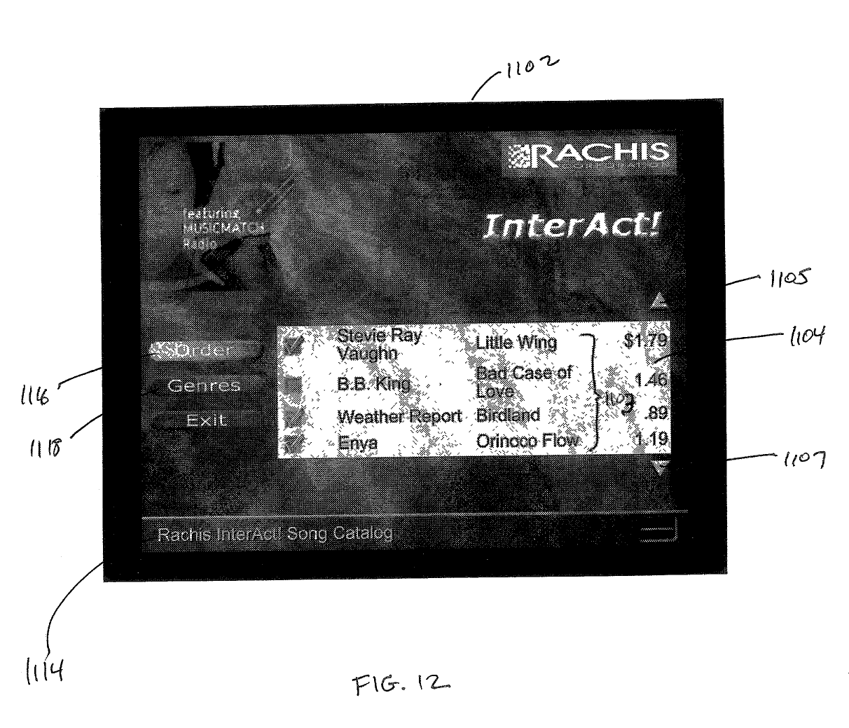

ShowAvailable.asp creates a list of all the “OnboardMapping” entries in the “OnboardMapping” tree whose ‘KeySong’ attribute matches an entry in the list passed in the OnBoardSongs. From each OnboardMapping, it extracts the RemoteID value. It eliminates duplicates and sorts the resulting union of the RemoteIDs. The function uses this canonical list to fetch all the nodes in the “AvailableSongs” collection that have an ‘ID’ node that is in the list, and displays it in the resulting screen, e.g., screen 1102 of FIG. 12. As shown therein, the user has selected using the checkboxes; and a list of the IDs of the selected songs is prepared and displayed. In the example shown, the list includes song, artist and price information, and the user has selected Stevie Ray Vaughn's “Little Wing”, Weather Report's “Birdland” and Enya's “Orinoco Flow”.

6.3.4 ConfirmOrder.asp

Arguments:

Songs: A collection of IDs that represent the selected items in Getuser.asp. They are used as the IDs of the entries in the “AvailableSongs” tree that the user wishes to purchase.

Processing:

ConfirmOrder.asp allows the user to review the total price of all the items selected, as illustrated in the display 1102 of FIG. 13 (“Order Confirmation for Jane Whalen”). The owner of InterAct! can add other charges here if desired. As shown in FIG. 13, ConfirmOrder displays the item descriptions and prices, and presents the user with a text entry box 1128 in which they can enter their authorization code (“Please enter your shopping password”). (Also provided are “View Cart” and “Cancel” buttons 1120,1126 having well-known functions.) ConfirmOrder.asp also passes the IDs and Prices of the items selected to the next page in HTML INPUT elements that have the HIDDEN attribute. They are passed as arguments by the text of the page itself, without user intervention.

6.3.5 Downloading.asp

Arguments:

SongID: A collection of integers that are the IDs of the selected songs.

SongPrice: A collection of decimal numbers that are the prices of the selected songs.

Processing:

Downloading.asp has several functions that will now be described in order of execution. Downloading first prepares the billing event. It uses the subscriber object that Getuser.asp saved into application memory and retrieves its subscriberid property. It then requests the Client.WtvBroker object to create a BillingEvent profile object. It populates the BillingEvent's properties as follows:

Subscriberid—The 64-bit GUID representing the subscriber. The value of this field is generated when the MSTV Server creates the user.

BillingEventType—Downloading.asp populates this with a string of the IDs of the selected songs.

CardNum—This is the name of the field that contains the credit card number or other identifier to be used in the transaction.

BillingEventAmount—This field is the total amount billed to the customer.

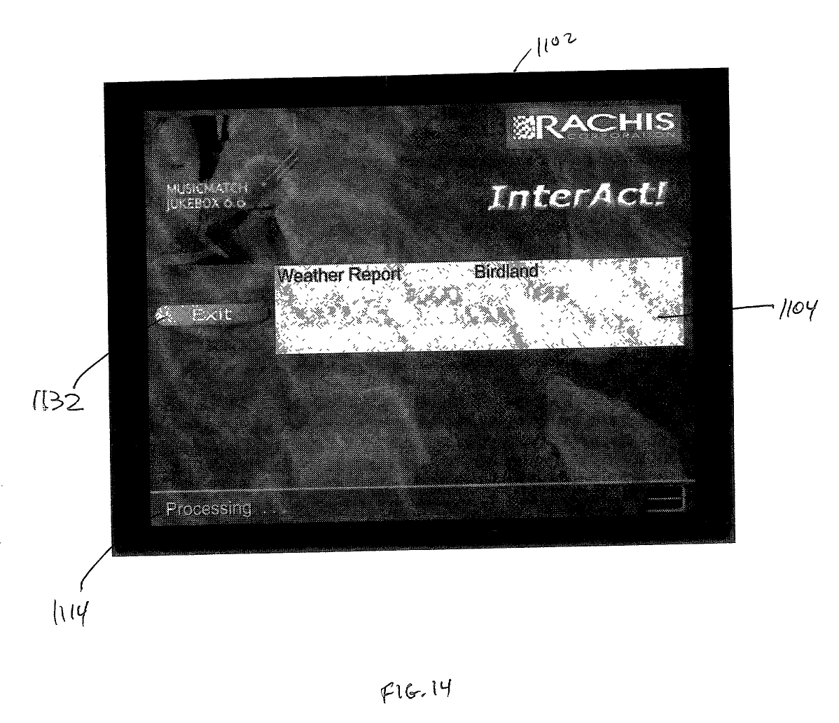

It then uses the SPO library to update the billing database, and display the relevant information. Downloading.asp also populates some application global variables that a transaction monitor listens for, as described elsewhere in this document. The application then invokes a client side Javascript that loops over the titles of the downloaded songs and displays the song in the status bar of the browser. A sample display 1102 is shown in FIG. 14. Note, for example, the display of “MusicMatch Jukebox 6.6; ” Weather Report—‘Birdland”’ at 1104 and the status bar display of “Processing . . . ” at 1114.

6.3.6 Listenframe.htm

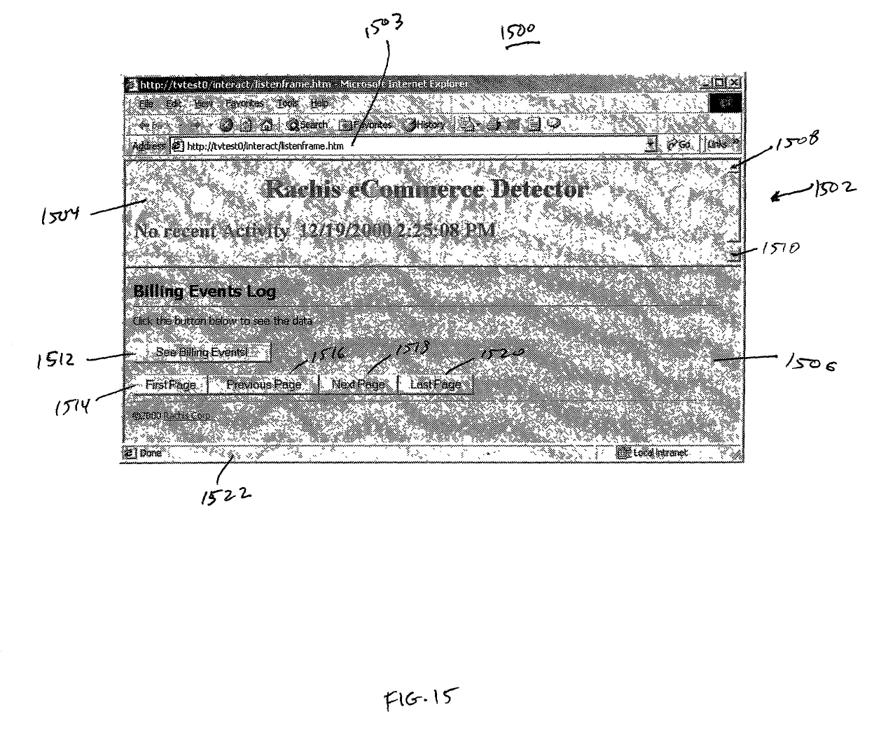

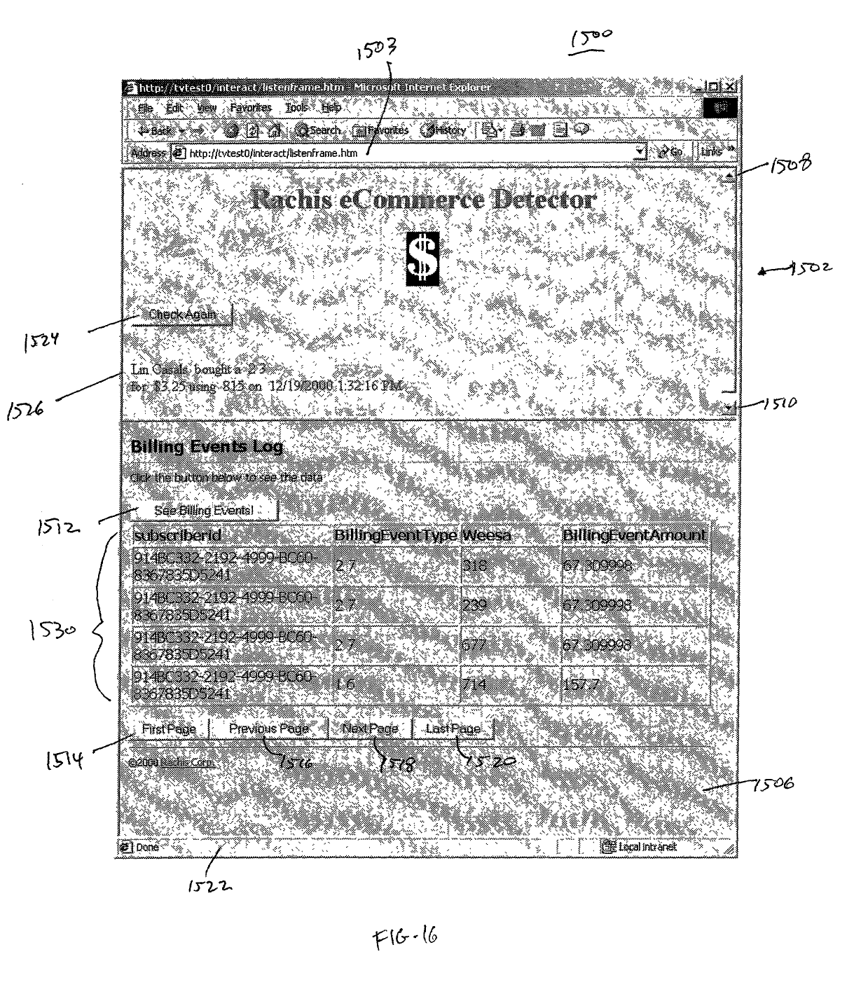

This function of the InterAct! application, described below with reference to FIGS. 15 and 16, is a separate web page 1500 consisting of a frame 1502 that contains two ASP pages 1504, 1506: Listen.asp and BillingEventsTable.asp. It is not called directly from the other pages, and is instead started in a separate context. In the examples discussed herein, these pages do not use any MSTV Server code.

6.3.6.1 Listen.asp

Referring now to FIGS. 15 and 16, in the illustrated examples, Listen.asp controls the upper frame 1504 in the window 1500, denominated the “Rachis eCommerce Detector.” It monitors the ASP application variables for Download. Asp's changes. When it detects them, it changes its initial display, as shown in FIG. 15 (“Rachis eCommerce Detector—No recent Activity”) to a display of the user's name, order amount, credit card number or other identifier, and the date and time of the transaction, as shown in FIG. 16 (“Lin Casals bought<item number> for $<price> using <credit card number> on <date, time>”).

Conventional browser window features can also be provided, including address bar 1503, navigation buttons 1508, 1510, and status bar 1522.

6.3.6.2 BillingEventsTable.asp

This ASP uses Microsoft's Active Data Objects (ADO) technology to create and update a table of the billing events. As shown in FIGS. 15 and 16, it uses the lower frame 1506 in the window 1500 (“Billing Events Log”) to display the fields of the table 1530, and provides navigation tools 1512, 1514, 1516, 1518, 1520 so the user can scan the entire contents of the database.

In the illustrated examples, the operations of these two windows 1504, 1506 (controlled respectively by Listen.asp and BillingEventsTable.asp) are completely independent of each other, and the user can respond to each one as if they were in separate browser windows. (This is a property of the FRAME HTML element.)

Thus, FIG. 15 shows the initial state of Listenframe.htm The “Rachis eCommerce Detector” has not yet detected any purchases, and the user has not clicked the button. Then, in FIG. 16, the eCommerce Detector has detected a transaction and displayed it. In the lower window, the user has elected to view some of the data. FIGS. 15 and 16 accordingly illustrate an e-commerce (or t-commerce) interface provided for the user in accordance with the PIA system.

6.3.7 XML file

The following discussion illustrates an example of the XML data source that the InterAct! application can employ. The XML code set forth below is directed to a music system, but it can be used for any system in which a list of categories, represented here as the “OnBoardSongs” tree, can be used to lookup a set of resources (the “Available Songs” tree), using the “OnBoardSongMappings” tree as a lookup table.

<?xml version=“1.0”?>

<!--
<%
'
' Copyright (c) 2000-2001 Rachis Corporation. All rights reserved.
' This product is protected by international agreement and treaty
' Unauthorized use is forbidden.
'
%>

<Song>

<ID></ID>
<Title></Title>
<Artist></Artist>
<URL></URL>
<Price></Price>

</Song>

-->
<SongData>
<OnBoardSongs>

<Song>

<ID></ID>
<Title></Title>
<Artist></Artist>
<URL></URL>
<Price></Price>

</Song>

<Song>....</Song>
<Song>....</Song>
<Song>....</Song>

```
  </OnBoardSongs>
  <AvailableSongs>
```

<Song>

<ID></ID>
<Title></Title>
<Artist></Artist>
<URL></URL>
<Price></Price>

</Song>

<Song>....</Song>
<Song>....</Song>
<Song>....</Song>

```
  </AvailableSongs>
  <OnBoardMappings>
```

<OnBoardMapping KeySong=“x>

<RemoteID>a</RemoteID>
<RemoteID>b</RemoteID>
<RemoteID>c</RemoteID>

</OnBoardMapping>
<OnBoardMapping KeySong=“x>

<RemoteID>a</RemoteID>
<RemoteID>d</RemoteID>
<RemoteID>f</RemoteID>

</OnBoardMappings>

</SongData>

6.3.8 BillingEvents Profile

Service Profiles are a MSTV Server facility. They provide a means for an implementer to create MSTV Server entities that have a unique interface, but without all the overhead of COM objects. Service Profiles are entries in an SQL Server database named the Profile Dictionary. The profile dictionary has a GUI that allows a user to create a profile using interactive tools. Since the profile dictionary is a simple SQL Server database, new profiles can be added by creating SQL Scripts that create table entries with the appropriate properties. The InterAct! application suite described herein includes SQL Server scripts that add the Billing Events Profile to the Profile dictionary.

6.3.9 BillingEvents Database

The BillingEvents Profile is simply a way for a client application such as InterAct! to access a database without having to use a SQL Server interface. That interface is beneath the Client.WtvBroker object that the client calls. The actual database that the Billing Events profile references is the Billing Events database. InterAct!'s installation software can include SQL Server script to initialize this database.

6.4 InterAct! Installation

InterAct! can be installed as a set of two kits, each in the format of a Microsoft Windows installer. The InterAct! web site can be installed with an InterAct.msi file available from Rachis Corp., the assignee hereof. The installation may include Billing Database creation and Billing Events Service profile creation, referred to as Rachis Extensions. These are SQL scripts that are installed into an appropriate directory. The user then runs the scripts manually. These extensions can be installed by running the Rachis Extensions.msi file.

Those skilled in the art will appreciate that the methods and systems described herein can be implemented in devices, systems and software other than Microsoft TV and CCS/CCA, that the examples set forth herein are provided by way of illustration rather than limitation, and that the scope of the invention is defined by the following claims.

We claim:

1. A method of invoking retrieval of software or data from a first source to a peripheral device capable of communicating with the first source, the method comprising:
detecting a device event generated by the peripheral device,
transmitting to the first source, in response to detection of a device event, a request to obtain the software or data from the first source, and
receiving the software or data from the first source, the software or data having been selected to be appropriate for the peripheral device in response to the event generated by the peripheral device,
wherein the steps of detecting, transmitting, and receiving are performed automatically when a device event is detected, without intervention by the user of the peripheral device.

2. The method of claim 1 wherein
the peripheral device is in communication with a client system, and
the detecting, transmitting and receiving steps can be executed even when the client system contains no device driver to support the peripheral device.

3. The method of claim 2 wherein the software or data from the first source includes a device driver appropriate for the peripheral device.

4. The method of claim 2 wherein the request to obtain software or data includes a code identifying a device type of the peripheral device.

5. The method of claim 2 wherein the first source is a local source on the client system.

6. The method of claim 2 wherein
the first source is specified by an identifier designating an entry in a database on a remote processor capable of communicating with the client system via a communications channel, and
the request is transmitted to the remote processor via the communications channel.

7. The method of claim 6 wherein the communications channel includes the Internet or World Wide Web.

8. The method of claim 2 further including:
causing the obtained software to be installed on the client system without a user of the client system manually installing the software.

9. The method of claim 2 wherein the event is generated upon user interaction with the peripheral device.

10. The method of claim 9 wherein the event can include actuating a device START button.

11. The method of claim 1 wherein transmitting a request for the software or data includes opening, in response to detection of a device event, a communications channel with the first source, to enable access to any of libraries, packaging or configuration data on the first source to establish a repository of device drivers and supporting applications suitable for the peripheral device.

12. The method of claim 11 wherein receiving the software or data from the first source includes receiving a package containing any of data, script files or software to augment a local database to enable handling of previously unsupported devices.

13. The method of claim 1 further including:
responding to events originating on a home network operating in accordance with a home network standard.

14. The method of claim 13 wherein the home network standard is the American National Standards Institute (ANSI) home network standard.

15. The method of claim 2 wherein the step of responding to peripheral devices is defined by a package resident on the client system, or on the first source.

16. The method of claim 15 wherein the package can be resident in the client system or obtained from the first source after detection of the device event.

17. The method of claim 2 wherein the responding includes:
navigating to a default web page when no software can be obtained from the first source to support the device.

18. The method of claim 2 further including:
utilizing a standard format to define device driver packages.
